(19) United States
(12) Patent Application Publication
(10) Pub. No.: US 2007/0112788 A1
(43) Pub. Date: May 17, 2007

(54) Development management system

(76) Inventors: Kim Patrick Kobza, Naples, FL (US); David A. Bankston, Naples, FL (US)

Correspondence Address: PATTON BOGGS LLP, 8484 WESTPARK DRIVE, SUITE 900, MCLEAN, VA, 22102, US

(21) Appl. No.: 11/640,395

(22) Filed: Dec. 18, 2006

Related U.S. Application Data
(63) Continuation of application No. 10/858,694, filed on Jun. 1, 2004.
(60) Provisional application No. 60/474,740, filed on May 30, 2003.

(51) Int. Cl. G06F 17/30

(52) U.S. Cl. 707/10

(57) ABSTRACT

A development management system and method for real estate or other projects permits participation in all phases of project management across a development management enterprise, as well as by a plurality of other entities having involvement in the management of one or more projects. The entities include, without limitation, architects, general contractors, property owners, and others, who may access the system and practice the method over the internet or other suitable network. The development management system may include, among others, a communications management system as well as a plurality of modules in communication with the communications management system, including a form management system, a product selection system, a community intranet or participation system, a warranty system and an interactive sales and marketing system.

This application claims the benefit, under 35 U.S.C. § 119(e), of provisional patent application No. 60/474,740, filed on May 30, 2003, the contents of which are incorporated by reference herein in their entirety.

### FIELD OF INVENTION

The present invention relates to an integrated business process system and method for simultaneously managing multiple development projects. In particular, the present invention relates to an integrated technology platform that enables real estate developers to manage and simultaneous track and capture all aspects of real estate projects using a single consolidated enterprise content management solution.

### BACKGROUND OF INVENTION

Real estate development and construction projects to a large extent involve millions of dollars of investment, are fraught with “all or nothing” risks during early phases of development, and require efficient exchanges of information between many different entities to avoid costly delays and mistakes.

From beginning to end, developers and construction companies are faced with the mammoth challenge of information management. There is a vast amount of critical information that must be made available to all relevant participants in the development process, both at a project level and across the organization itself. Mistakes and delays through miscommunication often lead to economic repercussions in the region of hundreds, thousands, or even millions of dollars. For example, when contractors and consultants make decisions that are based on incomplete and/or incorrect information, costly mistakes are likely to occur. In other words, information must be timely and it must be accurate. To this end, a technology driven information management solution is required to make sure that everyone receives the most up-to-date and accurate information when they need it.

Developers nowadays are forced to spend thousands and sometimes millions of dollars in “soft costs” getting projects off the ground. For institutional developers or franchises, the early phase processes associated with projects is often affected by the task of trying to manage geographically remote project teams from a corporate management location or headquarters. Moreover, local, state, and federal agencies generate repeated requests for information to back up zoning and permit applications, thus creating an excess of email transmissions, reams of paper documents, lengthy meetings and travel, and other fragmented communications.

An information management system that meets the lifecycle needs of real estate development and construction is needed by entities such as private real estate developers, general construction companies, and consultancies that serve the real estate developers. For example, consultancies may include planners, architects, engineers, and land management consultancies. Such an information management system may also be deployed by governmental agencies that also have to manage the implementation and construction of public works projects. Therefore, information management and project coordination must seamlessly occur across multiple entities, some of which may be geographically dispersed depending the nature of the project and its respective tasks.

In their attempts to solve the foregoing problems and shortcomings, construction companies have typically led the implementation of software in the real estate and development industry. Although such software may serve the needs of project management for individual projects, it rarely serves the enterprise-wide information management needs of either developers or general contractors. Similarly, providers of generic Enterprise Content Management (ECM) solutions have also attempted to serve the informational needs of developers. While these ECMs purport to satisfy some of the developer's information management needs, they have a limited, or altogether absent, vertical focus within the development industry that they serve.

It would therefore be advantageous to provide real estate developers and s general construction companies with a unified ECM information management solution that will solve practical challenges that are unique to the development industry. Such challenges include allowing project teams, for the first time, it is believed, to simultaneously manage the work flow process of multiple real estate development projects. The work flow process addresses, but is not limited to, due diligence, sales and marketing, construction, customer service, and product selection. Moreover, the workflow process provides a unified communication system that ensures timeliness of communication, maintaining consistency of information throughout a project life cycle, and cost saving by avoiding duplication and repetition.

### SUMMARY OF INVENTION

The long felt, but unmet, needs described, are at least in part addressed by an internet- or other network-based development management system for providing entities with a facility for managing real estate projects. The system comprises several aspects, including a form management system for providing online construction form communication and tracking management procedures for the entities engaging in the real estate projects. A construction data-entry communication device for entry and transmission of construction-related data is also provided. A communications system for providing real-time communications between the form management system and construction data-entry communication device receives transmitted construction development site data from the data-entry device and couples the development site data to the form management system.

Another aspect of the present invention comprises a computer-implemented system for centralized management of a plurality of construction projects. The management of the plurality of construction projects involves a plurality of entities each having a respective role. The system for centralized management comprises a communications management system and a plurality of modules. The plurality of modules are in communication with the communications management system. Each module provides functionality associated with a respective aspect of the management of each of the plurality of projects, where each module is accessible to respective entities having access authorization, and adapted to follow a pre-established workflow associated with the management of the plurality of projects.

In yet another aspect of the present invention, a computer implemented method for centralized management of a construction project comprises the; steps of maintaining a central repository in a storage medium, where the storage medium comprises data relating to the project. In response to a request by one of a plurality of members of a community of interest having a predefined role, for the project, selective access is provided to the data in the central repository on the basis of the predefined role.

Also related to the instant invention are co-pending, commonly assigned application Ser. No. 60/474,740, filed on May 30, 2003, and application Ser. No. ______, filed on Oct. 20, 2003, Express Mail No. EV 335857344US, entitled: Platform for Management of Internet-Based Public Communications and Public Comment, by Kobza et al., the contents of which are incorporated by reference herein in their entirety.

### BRIEF DESCRIPTION OF DRAWINGS

FIG. 1 illustrates a content management system according to an embodiment of an aspect of the present invention.

FIGS. 2A and 2B illustrate the components of the content management system's communication system according to an aspect of the present invention.

FIGS. 3A and 3B illustrate a community intranet module associated with the content management system according to an aspect of the present invention.

FIGS. 4A and 4B illustrate an Interactive sales & marketing system module associated with the content management system according to an aspect of the present invention.

FIG. 5 illustrates a product selection module associated with the content management system according to an aspect of the present invention.

FIG. 6 illustrates the customization process associated with product selection according to an aspect of the present invention.

FIG. 7 illustrates a warranty system associated with the content management system according to an aspect of the present invention.

FIG. 8 illustrates the modules associate with the form management system according to an aspect of the present invention.

FIG. 9 illustrates a Request for Information (RFI) process according to an embodiment of an aspect of the present invention.

FIG. 10 illustrates a process associated with an Architects Proposal Requests (APR) according to an aspect of the present invention.

FIG. 11 illustrates an Architects Supplemental Instructions (ASI) process according to an aspect of the present invention.

FIG. 12 illustrates a Construction Change Directives (CCD) process according to an aspect of the present invention.

FIG. 13 illustrates a substitution process according to an aspect of the present invention.

FIG. 14 illustrates a submittal process according to an aspect of the present invention.

FIG. 15 illustrates a Change Order Proposal (COP)process according to an aspect of the present invention.

FIGS. 16A and 16B illustrate an industry process diagram according to an aspect of the present invention.

FIGS. 17A, 17B, and 17C illustrate a punch processes according to an aspect of the present invention.

FIG. 18 illustrates the Development Content Management (DMS) System comprising a repository for the storage of content information, according to an aspect of the present invention.

FIG. 19 illustrates a repository access process associated with the Development Content Management System, according to an aspect of the present invention.

### DETAILED DESCRIPTION

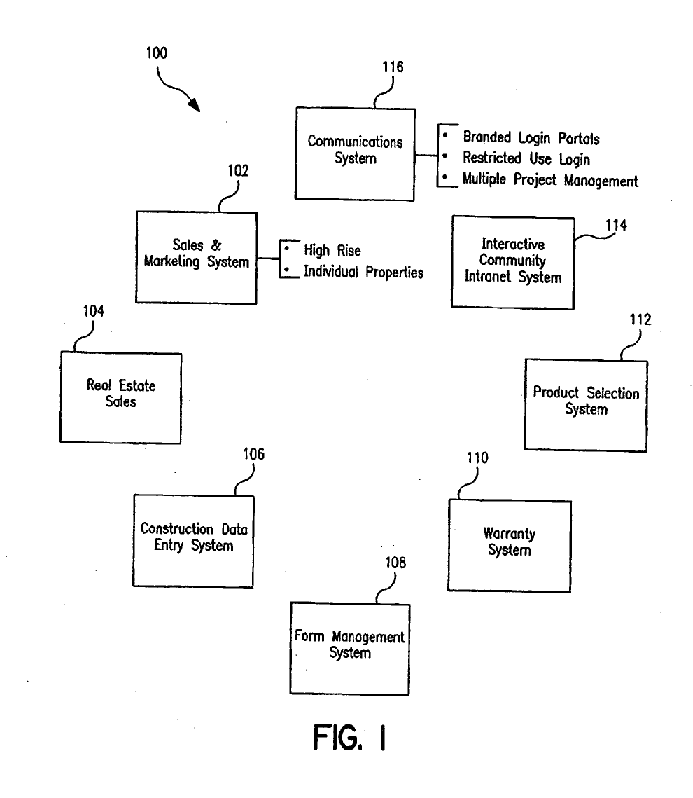

As illustrated in FIG. 1, according to an embodiment of an aspect of the present invention, development content management system 100 is a fully scalable infrastructure technology designed for, but not limited to, developers and general contractors with web-based capability, so that they may manage all aspects of development and building processes across their organization. The system provides an integrated business process system capable of simultaneously managing and tracking multiple development projects by managing content or data across all vertical facets of an organization. Accordingly, content management system 100 is an integrated enterprise based software system that simultaneously supports, for example, all external customer, executive, and project team communications that are associated with real estate development projects.

Content management system 100 provides developers with a centralized repository (not shown) for managing all communications, information, and various web-based application modules for each phase during the development lifecycle process. Apart from developers, the system may also be used by architects, engineers, construction managers, and planners, or any parties, project team members, or individuals that are responsible for managing an aspect or aspects of a development project. The system is, therefore, able to manage entire development projects from conception to the warranty phase, by providing central web access to these parties. Hence, the system enables developers to have one integrated web-based—or other network-based-management system which facilitates the management of large geographically distributed teams as a means of providing efficient form communication, punch list management, sales and marketing, product selection management, warranty handling, community governance, pre-construction planning, interactive sales, construction administration such as Request for Information (RFI) and Punch list functions, customer support and communication such as product and finish selection, post construction, community governance, and warranty work.

For each real estate development project, the platform supports the simultaneous management of internal and external communication through the use of multiple applications working together. As illustrated in FIG. 1, content management system 100 comprises application system modules, such as, sales and marketing system 102, real estate sales system 104, construction data entry system 106, form management system 108, warranty system 110, product selection system 112, and community intranet system 114. These application systems are accessed through a network (e.g., web) based, password protected communications platform such as communication system 116. Collectively, these application modules provide a process for managing communications, collaboration, and information, including, but not limited to, documents, images, videos, forms, punch data, warranties, and community governance.

Communication system 116 provides users with controlled access to the content management system 100, which is fully supported by administrative and security measures based on the role and access level of the user of users entering the system. These security and administrative measures include full information rights management, such as, providing a tiered user access at project, document, and image levels using a full authentication protocol, and also, assigning user rights and privilege assignments for system administrators, and project managers.

The platform, in one embodiment, is browser based, so that anyone/anywhere can manage, for example, project information, content associated with sales and marketing, customer information, or community intranets, simply using a web browser. Other modes of access are also possible. The system serves as a knowledge management tool that enables real estate developers to aggregate data on sales experience, customer experience, and construction experience and then to develop best practices based on this data.

Accordingly, the system 100 enables developers to manage their documents and images electronically across an enterprise in a manner that captures, collects, updates, and reports the content and data throughout the whole system almost immediately. So, for instance, if an image is used in one part of a development company such as real estate sales, it can be reused in another part of the company, for instance, marketing or construction.

Other features of development content management system 100 include external communication management through sales and marketing and interactive customer systems, which provides information associated with document management and publication, image management and publication, email notices, project calendars, and content management. Customer interaction is provided where customers are able to make product selections on-line, interactive sales-buyers are supplied with all documentation and visual imagery necessary to make an informed purchase decision, and buyers are able to selectively make choices relating to custom finishes, residential unit features, etc., online. Internal communication management (i.e., project communication), through simultaneous document management and publication is also facilitated. Multiple documents can be published to internal project teams, external Web sites or both. Simultaneous image management allows the publication of images to internal project teams, external web site, or both. Among other functionalities associated with the internal communication management feature are: standard project management tools; moderated discussions; content management; customer comment management, reporting and publication; survey creation; reporting; and publication.

A wireless delivery feature of system 100 provides tools for the wireless delivery of construction related data associated with punch lists and project management functions. The wireless delivery feature can be associated with construction data entry system 106 or other modules or systems associated with the development content management system 100.

The form management system 108 provides management of commonly used forms during the construction process or otherwise during the course of a development project. Once a form has been initiated, form management system 108 automatically notifies designated users who are assigned to that specific form via email or fax. The developer, contractor, or architect, for example, can view the form and respond to the form by providing any necessary updates, comments, questions, or instructions via the form management system 108, where it is further processed. Completing forms in form management system 108 reduces errors by increasing the clarity of form content and information. The form management system's 108 electronic notification greatly speeds the communication and collaboration processes. Also, as work transitions through a variety of forms, such as, for example, Change Order Proposals (COP) becoming Change Orders, form management system 108 automatically updates and upgrades the content of the forms to maintain consistency, easy tracking, and an accurate history log. These records may be maintained in a central repository or other locations for ease of access during or after a development project.

Product selection system 112 provides the developer with a means for communicating with homeowners in order to facilitate the viewing and pre-selecting of options and upgrades, generation of custom requests through an interactive web site, and making preliminary product selections using a web-browser. An electronic design center supplements the product selection system 112, which provides buyers with an electronic catalog to preview their numerous product selections.

Construction data entry system 106 is an electronic punch list/inspection management application that can be used both via the web (or other suitable network) or any handheld Pocket PC or Tablet PC device. The punch list process is useful in completing the building process. When a wireless device is used to update a punch list, the information or construction related data can be updated in the communications system 116, which manages the repository for all project information. Therefore, important punch data, as known to those of skill in this field, become accessible to the relevant application system module (e.g., warranty system).

The warranty system 110 provides warranty requests after construction. This enables the developer and the general contractor to manage the warranty process electronically, including communication with the homeowner and the sub contractors. Warranty system 110 can store or retrieve warranty information, as needed, to or from the central repository (not shown).

The Sales and Marketing System 102 provides developers, general contractors, and realtors with the functionality to manage and market their properties to prospective buyers prior to construction beginning. The system demonstrates construction materials, floor plans, 3-D modeling and other amenities to create a customized, virtual model for each residence, which is implemented using a secure and reliable Web-based platform.

Community intranet system 114 provides developers and homeowners with a way to communicate during the product selection phase. It also enables other community-related notifications, communications, and scheduling. Through the community intranet system 114, homeowners have access to an interactive online portal that provides a secure and convenient way for communicating with the developer, each other, and their building maintenance office. Information on meetings, scheduled community events, or maintenance updates and warranty requests may also be published using intranet system 114.

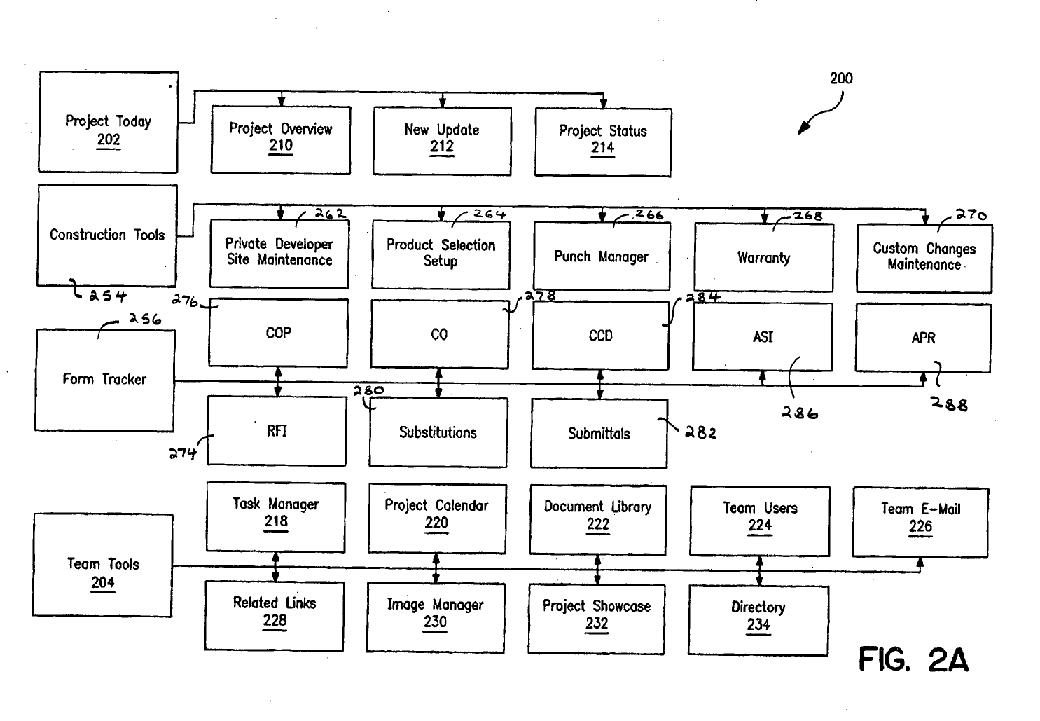

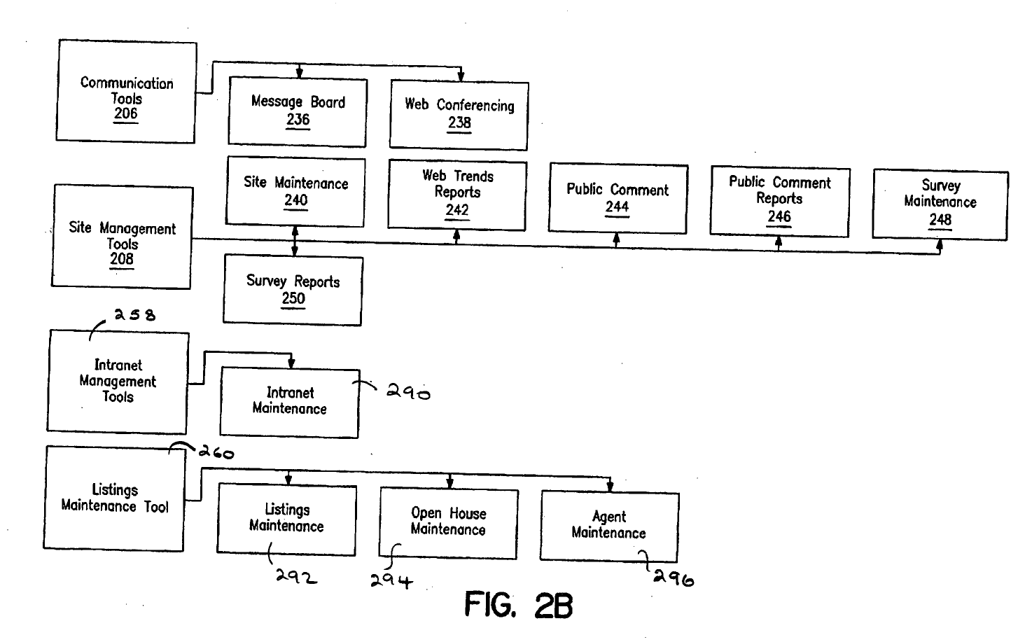

FIGS. 2A and 2B illustrate the components of communications system 200 according to an aspect of the present invention. Communications system 200 comprises a project component 202, a team tools component 204, a communication tools component 206, and a site management tools component 208.

Project component 202 comprises a project overview section 210, a new updates section 212, and a project status section 214. Project overview 210 providing an introduction to the overall project goals. New updates section 212 updates project team members (e.g., construction) on breaking news about the project, and the project status section 214 provides overall project status information.

The team tools component 204 comprises a task manager 218, project calendar 220, document library 222, team users 224, team email 226, related links 228, image manager 230, project show case 232, and directory 234. These components are project management tools that are accessible by project team members. For example, the task manager 218 provides complete task tracking information, while the project calendar 220 provides a means for adding personal and project events. Document library 222 may provide multiple document libraries within a project, where control and access to the documents is authorized by group/subgroup. The team users component 224 provides users with assignment rights and user access levels based on the role of the user (e.g., team member or project manager). Team email 226 provides all team members with a facility for electronic communication with project participants either individually, in groups, or all at once.

Communication tools component 206 comprises message board 236 and web conferencing components 238, where the message board 236 provides project team communication by allowing users or team members to interactively discuss topics online.

Site management tools component 208 comprises site maintenance 240, web trends reports 242, public comment 244, public comment reports 246, survey maintenance 248, and survey reports 250.

Other illustrated components and modules are construction tools 254, form management system 256, intranet management tools 258, and listings maintenance tools 260. These components (i.e., 254, 256, 258, and 260) and the communications system components (i.e., 202, 204, 206, and 208) functionally comprise both a development content management system (DMS) and a public comment system (PCS). Construction tools 254 comprises a private developer site maintenance tool 262, a product selection tool 264, a data punch manager 266, a warranty system 268, and a custom changes maintenance tool 270. The form management system 256 comprise a request for information (RFI) tool 274, a change order proposal (COP) tool 276, a change order (CO) tool 278, a substitutions tool 280, a submittals tool 282, a construction change directives (CCD) tool 284, an architects supplemental instructions (ASI) tool 286, and an architects proposal request (APR) tool 288. The intranet management tools component 258 comprises an intranet maintenance tool 290. Listings maintenance tool component 260 comprises listings maintenance tool 292, open house maintenance tool 294, and agent maintenance tool 296.

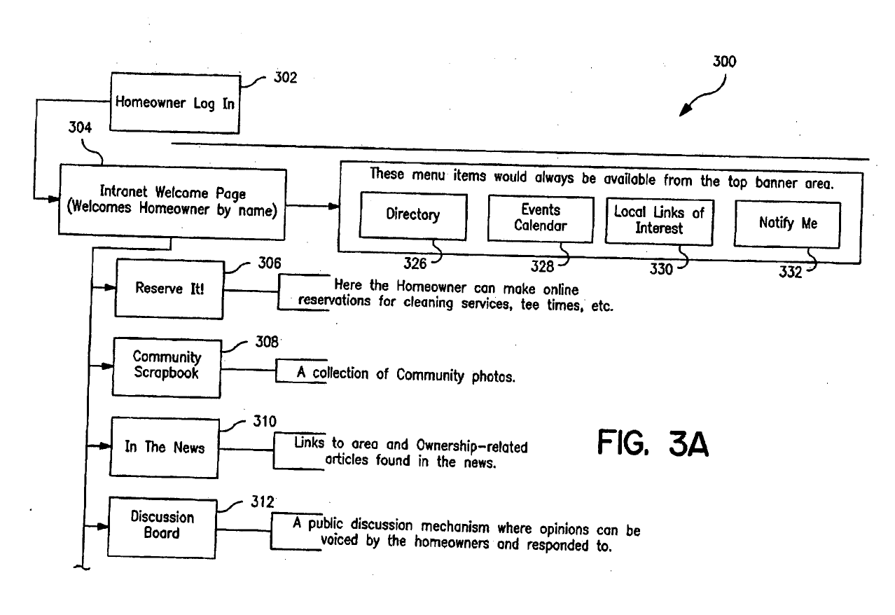

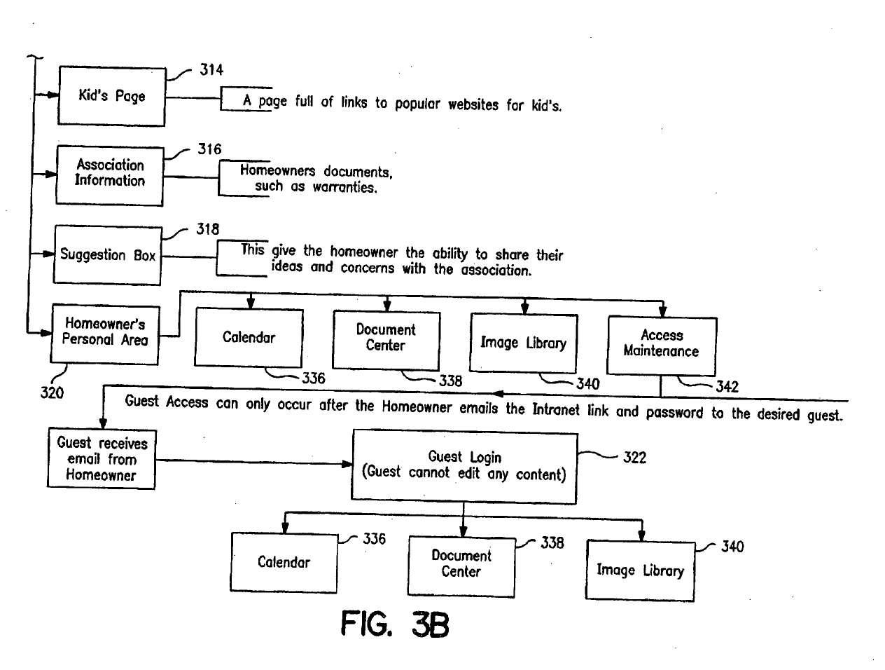

As illustrated in FIGS. 3A and 3B, according to an embodiment of an aspect of the present invention, community intranet system 300 is designed to manage the information new homeowners will need to maintain their property throughout the period of their residence. Although described with reference to the residential homeowner context, these principles and approaches can also be applied as needed in the commercial real estate context. This system is dynamically linked to provide interaction between the contractor, developer, and homeowner on issues such as residence customizations, warranty requests, and association information.

Homeowners are also provided with a personal area where they may communicate with family members. Information shared may include personal documents, images or calendar events. Special features are added to keep the homeowner updated on upcoming events or new information pertaining to their home. In addition, service requests are available to minimize effort needed to schedule the use of property services and amenities.

Community intranet system 300 comprises a home owner login 302, an. Intranet welcome page 304, a reserve section 306, a community scrap book 308, a news section 310, discussion board 312, a children (or Kid's) page 314, association information 316, suggestion box 318, homeowner's personal area 320, and guest login 322.

At the homeowner login 302, each homeowner is set up with a username and login specifically for them. This gives them password-protected entrance to their Web-based community intranet. Once the homeowner has logged in, internet page 304 welcomes the homeowner by their name and provides an introduction to the community intranet 300. Within the intranet welcome page 304, the user or homeowner may access menu items such as directory 326, events calendar 328, local links of interest 330, and “notify me” 332.

Directory 326 is available from the top banner and includes contact information for the staff, residents, association members, etc; for the community. Residents have the choice of whether or not to be included on this community intranet.

Events calendar 328 is also available from the top banner and shows a monthly view of the community calendar. The homeowner may can go back as far as they want to in order to view old events and go forward as far as they want to view future events, month by month. If an event is added, it will be viewable on the specific date. A link may be clicked in order to illustrate further details.

Local links of interest 330 provide web links, where the links are grouped for better organization. A number is in parentheses after the group name to denote how many links are within that group. The name of the link as well as a brief description can also be seen. Clicking on the name of the link opens up a new browser window and takes the homeowner or user into that site. Therefore the homeowner is not leaving the community Intranet site, but rather opening up a new window.

The tool or module labeled “Notify me” 332 permits homeowners to sign up to receive email notification when certain parts of the site are updated. All of the parts are broken down individually so the homeowner may choose which ones he/she would like to receive notification on. Some notification examples may be events that are added, documents that are added to the news section, or the addition of a new model to the community. The homeowner also has the ability to opt-out of this email notification at any time.

The reserve section 306 allows homeowners to sign up for any available concierge services the community offers. In order to sign up, they may send an email notification to the appropriate person responsible for arranging the service or services of interest. Some examples may be making reservations for certain restaurants, signing up for tee times, arranging for dry cleaning picks up, etc.

Community scrapbook 308 enables homeowners to view photos relating to their community. Examples of photos that may be included may be a community barbeque, a holiday party, an outing, etc. The images are arranged in groups for better organization. Thumbnail view, full image view, slide view are the three views that are selectable by the user.

News section 310 allows homeowners to view documents relating to their community. Some examples of documents may be press releases regarding the community, monthly newsletters, etc. The documents are arranged in groups for better organization and a number is in parenthesis after the group name to denote how many documents are within that particular group. The user may see a date, title and description for the different documents. The title links to the actual document, which opens into a new browser.

Discussion Board 312 provides homeowners with the opportunity to take part in a threaded discussion board. Topics are posted and the homeowner is encouraged to voice his or her opinion. Since all homeowners desiring access are required to log into the community intranet 300, any comments posted will not be anonymous. They will reflect the name of the person logged in, as well as a date stamp that is added to see when the comment was posted. The homeowners also have the ability to reply to comments posted by other homeowners. All topics, comments and replies are viewable by anyone logging in.

Kid's Page 314 provides a resource of links for children. All links added in-this section are “kid-friendly.” The links are grouped for better organization and a number is placed in parenthesis after the group name to denote how many links are within that group. The user may see the name of the link as well as a brief description. Clicking on the name of the link opens up a new browser window and takes the user or homeowner into that site. Therefore, users are not leaving their community intranet site, but rather opening up a new window.

Association information 316 provides homeowners with an overview paragraph about the association, as well as any documents that may be related to the association. The documents may be arranged in groups for better organization, where a number is placed in parentheses after the group name to denote how many documents are within that particular group. The user may see a date, title and description for the different documents. The title links to the actual document, which opens into a new browser.

Suggestion box 318 supports online suggestions by homeowners, whether they be ideas or concerns relating to the community. All suggestions are sent to the association via email from the community intranet 300.

Homeowner's personal area 320 may contain text from the homeowner to welcome his/her guests. The text can be dynamically updated at any time, but only by the homeowner. This may represent the homeowner's main page within personal area 320. Homeowner's personal area 320 may also comprise a calendar 336, document center 338, image library 340, and an access maintenance 342 part. Calendar 336 provides the homeowner with the ability to add events to a personal monthly calendar at any time, the calendar viewable only by the homeowner when logged in, or by any guests the homeowner allows access to. Events can be added only by the homeowner.

Document center 338 provides the homeowner with the ability to add documents to a personal document center at any time. As with the calendar section 336, the documents within the document center 338 are viewable only by the homeowner logged in or any guest the homeowner allows access to. The documents can be arranged in groups for better organization, whereby a number is placed in parentheses after the group name to denote how many-documents are within that particular group. The user has the ability to see a date, title, and description for the different documents. The title links to the actual document, which opens into a new browser.

Image Library 340 enables the homeowner to add images to their own personal image library at any time, where these images are only viewable by the homeowner logged in, and/or any guest the homeowner gives access to. The images can be arranged in groups for better organization. Also, images may be viewed in thumbnail view, full image view, and slide view.

Access Maintenance 342 provides the homeowner with the ability to give access to guests, so that they may view the main page of the homeowner's personal area 320, the calendar 336, the document center 338, and image library 340. The homeowner may create a password and enter email addresses for all those that he/she wishes to grant access to. The homeowner can change the password at anytime but must subsequently send another email to those the homeowner wishes to give access to in order to inform them of the new password.

Under the guest login 322 feature of intranet 300, if the homeowner signs up a guest to have access to their personal area 320, the guest would receive an email which includes the password the homeowner created and a link to the site (i.e., personal area). The guest may simply go to the link provided in the email and login using the given password. Once logged in, the guest is able to view/read the information contained in the homeowner's personal area 320. The guest, however, does not have the ability to change any information entered in the homeowner's personal area 320.

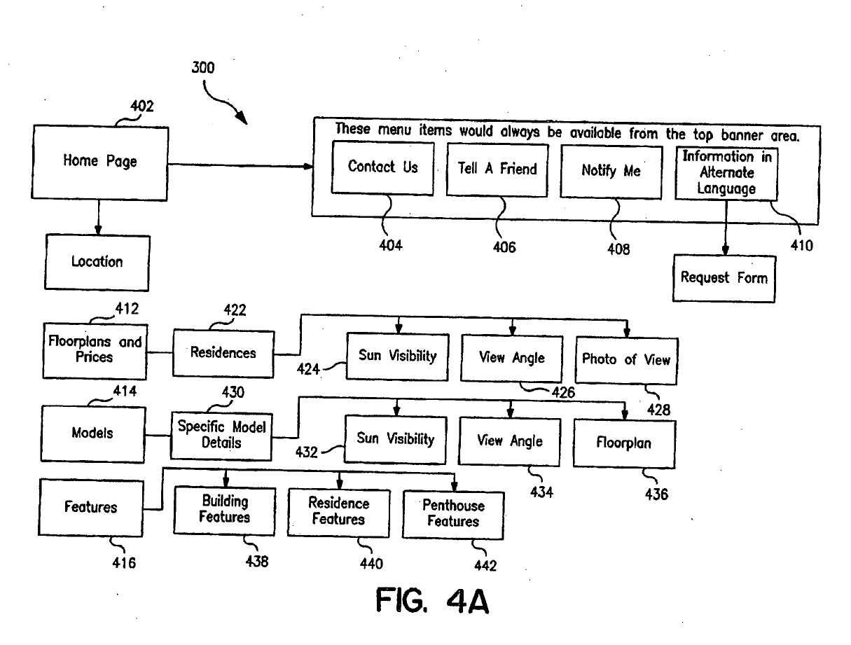

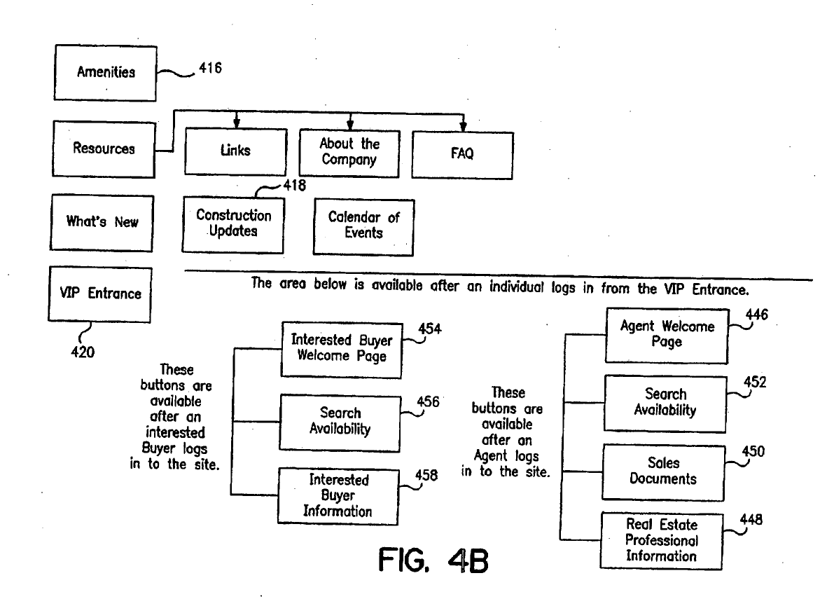

FIGS. 4A and 4B illustrate an Interactive Sales & Marketing System 400 according to an embodiment of an aspect of the present invention. The Interactive Sales & Marketing System 400 provides a means to market a real estate product during its pre-construction, construction and post-construction phases. This system comprises two main functionalities, namely, information management through the communications system 116 (FIG. 1) and information provided through a Public/Password protected site. Information managed through the communications system 116 (FIG. 1) includes all related residence information, homeowner/buyer information, as well as the graphic files associated with this information. Much of the managed information is made readily available to the prospective buyer through a dynamic public website. In addition, areas of information such as residence availability, exact pricing, fees, dues, etc., are made available only to prospective buyers that submit contact information. Based on this information, an expiration can be set in order to encourage new opportunities for contact between the prospective buyer and a sales person.

Interactive sales & marketing system module 400 is accessible through home page 402, which comprises lead generating tools such as, contact us 404, tell a friend 406, notify me 408, and information selection in an alternative language 410. The tools are available from a top banner within the home page 402 area. Sales & Marketing System 400 also comprises information access to dynamic floor plans and pricing 412, model maintenance 414, features and amenities 416, construction updates 418, and a VIP access entrance 420.

From the dynamic floor plans and pricing 412 area, graphic floor plans may be uploaded to the communications system 116 (FIG. 1) and-simultaneously made available for web viewing or other network access. Pricing is dynamically calculated based on existing product availability. Also, related architectural diagrams are uploaded to their associated floor plan layout through the floor plan maintenance available in the back end and simultaneously available for web viewing or other network access. In addition to floor plans and is pricing for different residences 422, other accessible information may include sun visibility 424, view angle 426, and a photo of the view 428.

In the model maintenance 414 feature, as models become available for customer walkthroughs, residence data can easily be associated with each individual residence. When activated, information such as model images, designer information, model description, etc may be accessed through model details 430. Other accessible information also includes sun visibility 432, view angle 434, and a photo of the view 436.

Also in the model maintenance 414 feature, via the web or other network, a model thumbnail is automatically generated based on the toggling of a selected uploaded image. Moreover, automatic public listings displaying all model related information is generated.

Features and amenities 416 are dynamically entered to provide customer updates as a project, for example, continues. These feature may include building features 438, residence features 440, and penthouse features 442.

In construction updates 418, as construction continues, images are uploaded into a dynamic area, where they are dated. The images also include short and long descriptions. The images may be sequenced as needed regardless of upload order. Slide views of all uploaded images are also available. Also, web pages or other network accessible data are automatically added as new dates are entered into the maintenance area of the back end system.

The VIP entrance 420 is a lead-generating area that allows prospective buyers to submit their contact information in exchange for additional purchasing information such as, residence/property availability, exact residence/property pricing, detailed floor plans and other architect supplied documents, search capabilities for narrowing results including floor level, interior/exterior location, north/south/east/west preferences, associated fee reports, and construction related documents. This information is accessible to the prospective buyer through the interested buyer welcome page 454, search/availability 456, and interested buyer information 458.

Through VIP entrance 420, outside agents are also granted restricted access via an agent welcome page 446 in order to gather product information including agent commissions 448, sales/contract documents 450, and showing times/availabilities & search access 452.

Contact us 404 allows for direct opportunity to request additional product information. Tell-a-friend 406 creates an easy customer opportunity to share site information with friends, relatives & associates. Information may be stored for sending additional notifications. Notify me 408 provides the prospective buyer receive information automatically as it becomes publicly available on the site. Information submitted may include as little as an e-mail address and name. For added lead generating opportunity more information may be required. This information can then be stored in a .csv file, for example, for later use in direct mail opportunities. Information in alternative languages 410 enables project information to be translated in chosen alternative languages. All related contact forms and confirmation e-mails are also translated for ease of customer use.

Interactive Real Estate Sales & Marketing System 104 (FIG. 1) accommodates the needs of highly active real estate agencies. This module comprises MLS listings management, which includes complete database management system for all MLS listing related information; an agent maintenance system for providing a complete database management system associated with the MLS listing database (Agents are able to be associated as teams for shared listings); dynamic property web listings for retrieving data from the existing database. Extensive search functions provide prospective buyers with excellent narrowing capabilities in the context of searching. Listings may be retrieved by price, bedrooms, bathrooms, neighborhood, property type, listing agent, virtual tour, open house, mapped area, or zip code. Interactive real estate sales & marketing system 104 (FIG. 1) also comprises a public/private contract management, which includes a document Library organized by a public/password protected dynamic database. Document-associated permissions are controlled through the backend system. The module 104 also comprises a dynamic openhouse management which comprises a dynamic database for managing upcoming openhouses that are associated with MLS Listings.

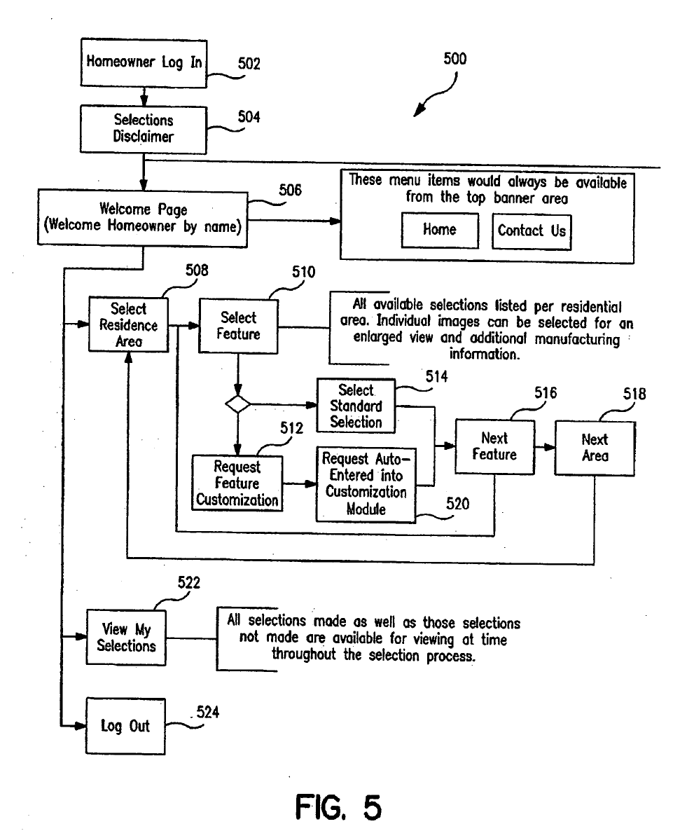

FIG. 5 illustrates the product selection system 500 according to an aspect of the present invention, where the system 500 allows the homeowner to carry out product selections for their homes online. A homeowner would need to login to their personal Intranet (FIGS. 3A and 3B) where they are given a list of areas/rooms in their home. Depending on the area they select, they are presented with the feature options and selections for each feature in the room. The homeowner can mark their selection and save it online and, therefore, does not have to do all of his/her selections in one session. This module 500 comprises a product selection setup, which is a process where the user (e.g., developer) has the ability to setup all rooms/areas for a residence. This module also provides a very flexible method for setup feature descriptions and their various selections with sample pictures, for each room in the residence. Module 500 also comprises a home product selection, which lets the homeowner see all the information that has been initially setup, providing the user with the opportunity to make selections for various features in different rooms. Each feature can have multiple selections and the homeowner must select one of them. If the homeowner doesn't want any standard choices, he/she also has the option to put their custom requests in an email and send that to the developer.

Product selection system 500 is an automated and flexible process that helps the homeowners do their selections for their homes online. The developer, who is responsible for setting up the rooms for residences, has a very flexible and user-friendly way to store the entire structure of the homes by defining each separate room in a residence. Defining rooms/areas in a residence also enables the developer to use that data for other purposes such as in the punch process. This module 500 allows the Developer to enter very detailed description about each feature and selection. Also, it gives them a very simple way to upload sample pictures for each selection. The detailed description and sample pictures give the homeowner a very clear idea for each of the selections. The module also takes into account the situation where a homeowner can own more than one homes in a development.

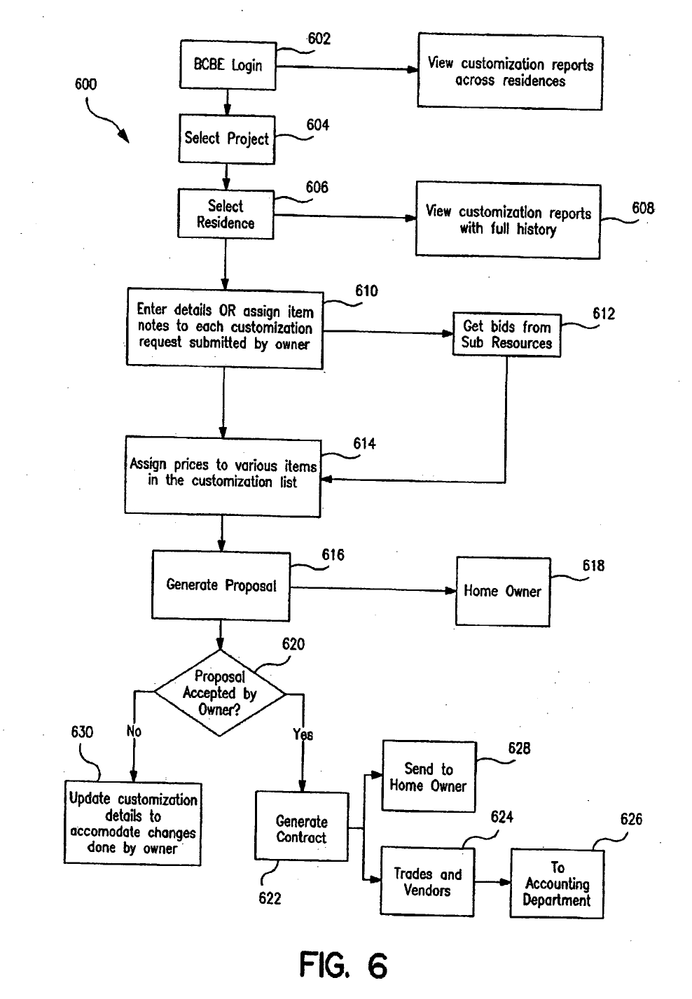

At step 502, whenever the homeowner logs onto the intranet and clicks on product selection, the system 500 knows what homes the person owns so it is able to provide the homeowner with a list of homes that belongs to homeowner. If the list contains only one home then the homeowner is taken to the “Select Rooms” list box. If on the other hand the homeowner owns more than one home, he is presented with the list of homes from which the product selection process can take place. At step 504, once the homeowner has logged into the system, he/she is presented with a disclaimer associated with the selections. At step 506, the homeowner is welcomed by name, and as previously indicated, depending on the number of homes the homeowner owns, is presented with a list of residences. At step 508, the homeowner may select their residence area. Once this area has been selected, at step 510, the homeowner may select features that are associated with the selected residence area. The homeowner has the option of requesting a feature customization at step 512, or selecting a standard choice as indicated at step 514. If the homeowner makes a standard selection, at step 516 another feature may be selected by returning to step 510. Alternatively, at step 518 another residence area may be selected by returning to step. 508. Alternatively, if at step 512 the homeowner makes a customized feature request, at step 520, the request is automatically entered into a customization module (FIG. 6), which is also an application system module associated with the content management system 100. Once the customization request has been made, at step 516, another feature may be selected by returning to step 510. Alternatively, at step 518, another residence area may be selected by returning to step 508. At step 522, all selections made by the homeowner are available for viewing throughout the selection process. At step 524, the homeowner may log out from the product selection application module 500.

FIG. 6 illustrates the customization process according to an embodiment of an aspect of the present invention. The customization process actually starts when the homeowner has requested some custom changes to his/her residence, which changes are not covered in the standard selections. These requests are submitted through the product selection process 500 (FIG. 5). Custom changes may comprise area customizations, which are customization requests that can affect the whole area/room in the residence. These are basically construction changes that can also affect the layout and the floor plan of the residence. Custom changes may also comprise feature customizations. If a homeowner is not interested in the standard selections, the homeowner may make “custom feature Requests” that will fall into this category.

At step 602, the user has logged into the system and may select a project at step 602. Based on the selected project, at step 604, a residence of choice may be selected. At step 608, customization reports associated with the selected resident may also be viewed with a full history. Once the residence is selected, at step 610, details and notes may be made with respect to each of the customization requests made by the homeowner during the product selection process. At step 612, bids may be requested from sub-resources, such as, for example, sub-contractors. Based on this bid, at step 614, prices are assigned to the various items in the customization list or requests. Once the prices are assigned to each of the customization requests, at step 616, a proposal is generated for the homeowner. At step 618, this proposal is sent to the homeowner for review. At step 620, the homeowner may accept or reject the proposal. If the proposal is accepted, at step 622, a contract is generated. At steps 624 and 626, the generated contract is sent to the corresponding vendors and to the accounting department, respectively. At step 628, the contract is also sent to the homeowner. If the proposal is not accepted, at step 630, the customization details ate updated to accommodate and reflect the changes introduced by the homeowner.

The Warranty System provides a means of submitting, tracking and responding to customer warranty requests. Requests can be directly entered into the system by the homeowner through their community intranet or by the building manager/developer through the back end system. Regardless of how it is entered, the homeowner can track “automatically updated status and comment areas” to receive the most current information available for the requested warranty tasks.

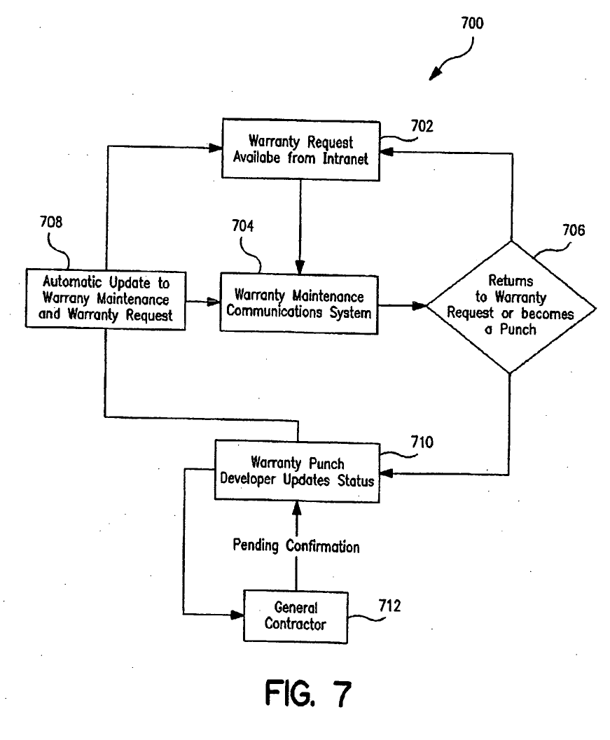

FIG. 7 illustrates the warranty system process according to a embodiment of an aspect of the present invention. The Warranty process would begin with the homeowner making a warranty request at step 702. At step 704, the warrant request is made by entering the warranty maintenance 's ection of the homeowner's community Intranet. Since this is a password-protected Intranet, the homeowner only has the ability to fill out warranty request forms for the residences that he or she is associated with or owns. The homeowner would fill out the appropriate information on the Warranty Request Form.

The warranty form includes information such as who the request is reported by, a contact phone number, which residence they are requesting this for if multiple residences are owned, a brief description of the request, or whether or not the homeowner wants the building manager to come into their residence or whether they want everything coordinated directly with them. The homeowner would then click on the relevant portion of the intranet screen. At step 706, once the request is sent, the homeowner or user returns to the warranty request screen at step 702.

The requests are received by whoever is designated to receive them. For example, a representative of the developing company may receive the request, or even the building manager for that particular community. The homeowner may track the progress of their warranty request by checking his/her community intranet at any time, which is dynamically updated throughout the entire process, as indicated at step 708. The homeowner is not only able to see if/when the warranty request has been fulfilled but he/she is able to see all comments added by the developer and general contractor throughout the entire process.

Any requests the homeowner has added at any time will all be logged within a section of their community intranet. This gives them an entire history of all requests comprising the date initiated, any comments added by the developer, and general contractor and status.

The developer would receive an email notification from the warranty request generated by the homeowner. At the same time a warranty item is being generated in the back end of the communications system warranty maintenance section based upon the information filed out on the intranet by the homeowner. The developer would view all of the requests made by the individual homeowners. Warranty requests can be viewed based on their status as well as by specific area.

If a warranty request is made into a punch issue, as indicated at step 706, additional information is provided by the developer to the person responsible for fixing the issue (e.g. general contractor), as indicated at step 710. Once information is filled out, at step 712, notification may be sent to the general contractor either via email or fax. The developer may add comments at any time to communicate an issue with the general contractor. The developer may accept or reject both the notification and/or the work from the general contractor. If accepted, at step 710, the developer updates the status of the punch issue. Once the status of the punch issue is updated, at step 708, the warranty maintenance section and the homeowners community intranet (i.e., warranty request) are automatically updated.

Once the general contractor receives notification in the form of an email as or fax notification, the general contractor is responsible for addressing the issue. The general contractor may update the status once the issue has been fixed and then update the status of the punch item by sending an email notification to the developer. The general contractor would then await confirmation from the developer. If the developer accepts the work, the general contractor has nothing more to do with this particular punch issue. If the developer rejects the work done by the general contractor, then the general contractor would need to readdress the issue.

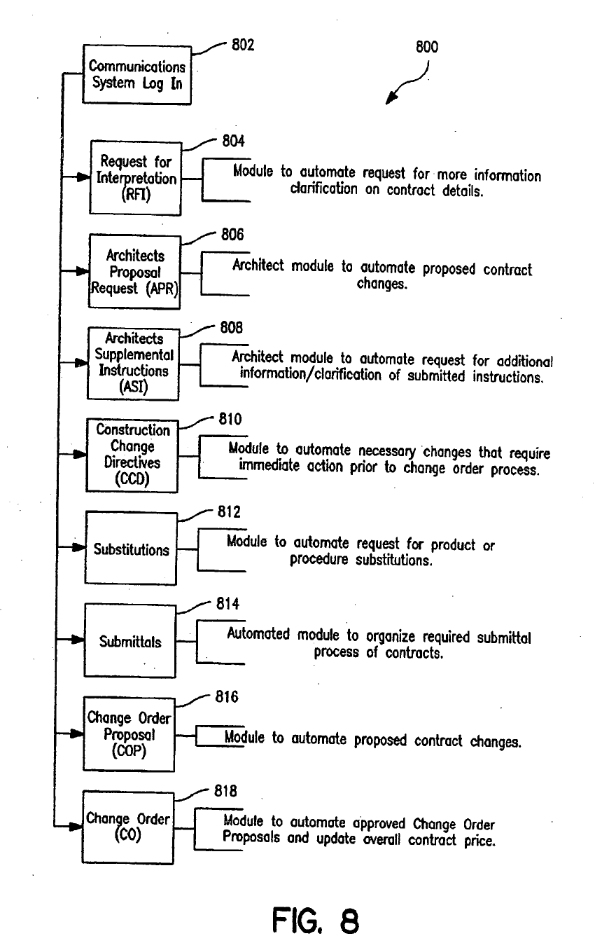

FIG. 8 illustrates the form management system 800 according to an aspect of the present invention. Through automated procedures provided by form management system 800, architects, developers and general contractors can easily communicate and provide pertinent project related information, especially, where time sensitive decisions are necessary. The form management system provides a suite of modules that help acquire, complete, report and track construction forms in one location.

Form management system 800 provides tools that allow users to view cross sections of data and compare the results to either other areas in the same project or other projects across the enterprise. Automatic notifications help keep the process moving at a reliable pace by immediately sending emails to designated members when a document is generated, updated, revised, or approved. The form management system 800 is, thus, a centralized and secure web-based application that is accessible to any designated member of the project team. Therefore, centralized communication between and among owner, contractor, subs, architect, engineer, etc. is facilitated. Also, standard form templates can be customized for specific project record forms and documents, as well as providing access to general communication records, memos and logs, and Weekly/Monthly reports.

As illustrated in FIG. 8, form management system 800 comprises a logging-in means through the communication system 802, a request for information module (RFI) 804, an architects proposal request module (APR) 806, an architects supplemental instructions module (ASI) 808, construction change directives module (CCD) 810, substitutions module 812, submittals module 814, change order proposal (COP) module 816, and a change order (CO) module 818.

The request for information (RFI) module 804 provides an interface for any member of a project to electronically draft an RFI form. The most likely scenario would start with a general contractor sending an RFI to an architect for interpreting instructions given on project drawings or documents. The RFI module submits the question to the designated person and can also be copied to any other member of the project for read-only purposes. The selected person may then log into the system to generate the response. Upon generation of the response, this person can collaborate with any member of the project under a comment area for the RFI. After an official response is given, the RFI status is set to “Finalized.” This status would require that the originator review the response and close the RFI. If the response is not sufficient, the originator would then set the status back to open, which would require the interpreter to elaborate on the response. This process would continue until the originator closed out the RFI.

The module 804, among other things, provides the ability to attach an runlimited amount of documentation to an RFI, provides automatic notification of RFI activity, ability to search and filter out RFI data, keeps sequential order, and collects data comprising subject, TO, carbon copy, request, recommendations, attachments (Unlimited), drawing number., reason for request (e.g., insufficient information), action requested (e.g., approval, direction, etc.), priority (e.g., high), due date, cost effect (e.g., increase cost), time effect (e.g., decrease time), actions (e.g., view RFI, down load RFI document).

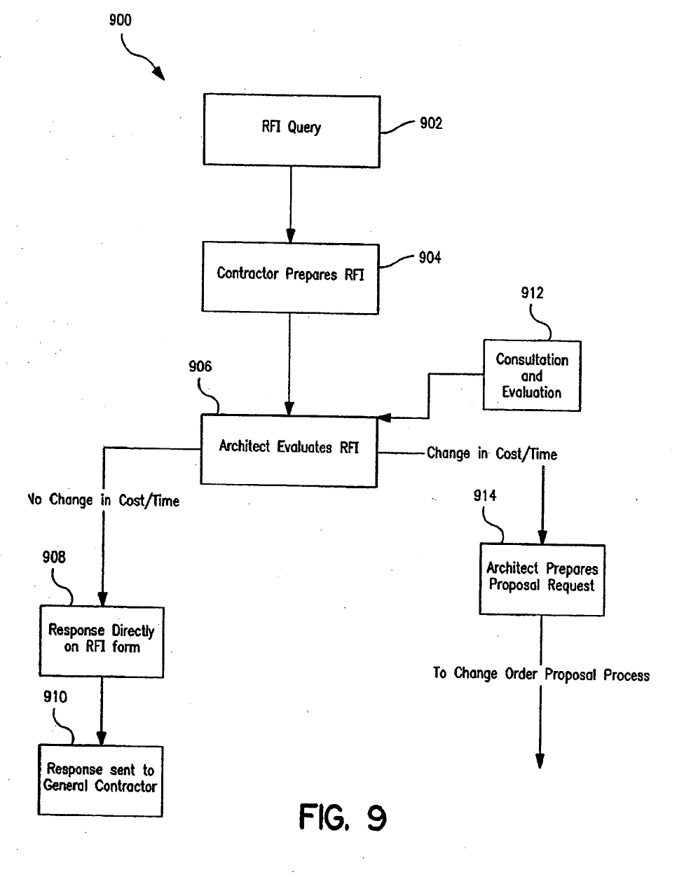

FIG. 9 illustrates an example of an RFI process 900 according to an embodiment of an aspect of the present invention, where at step 902, the RFI module is accessed. At step 904, the contractor prepares an RFI and sends the RFI to the architect. Upon receiving the RFI, at step 906, an architect evaluates the. RFI and determines whether any changes in cost or time are anticipated. During this evaluation, at step 912, additional consultation and evaluation of the RFI may also be made. If no changes are required, at step 908, the architect responds to the RFI directly on the RFI form. At step 910, the response is sent to the general contractor. If on the other, changes in cost or time are anticipated, at step 914, the architect prepares a proposal request, which is handled by the change order (CO) proposal process.

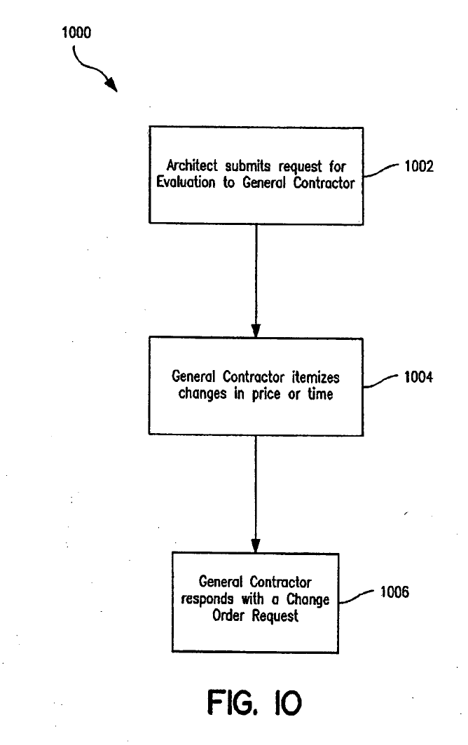

Architects proposal request (APR) module 806 (FIG. 8) provides an interface for architects to electronically create an Architects Supplemental Instructions (ASI). FIG. 10 illustrates a process 1000 associated with an APR according to an aspect of the present invention. In step 1002, architects may fill out the appropriate information in an itemized format, finalize the document, and then send the document to the general contractor for evaluation. At step 1004, the contractor itemizes changes in price or time. The general contractor can then respond with a Change Order Proposal (COP) by importing the Architects Supplemental Instructions (ASI) items into the COP module, as indicated in step 1006.

The Architects proposal request (APR) module 806, among other things, provides the ability to attach a separate document to each item in the APR; default information is automatically created upon generation of new APR forms, thus, reducing the need for duplicate data entry; providing the use of color coding status (e.g., not issued); keeping sequential order; and actions (e.g., view APR).

APR Module 806 allows a user to generate an electronic ASI form. The user is prompted to enter/select information comprising CSI (construction specifications institute) code information, description, and recipient (e.g., general contractor). Once the information is saved, the user can then add an itemized list of changes they wish to have included in the proposal. Data comprising description, document attachments, date. Upon the creation of at least one item, the user can then finalize the document. This will cause an email to be sent to the recipient (general contractor) prompting them to login in to the system and view the APR. After reviewing the document, the recipient may choose to respond to this APR with a Change Order Proposal document in compliance with standard AIA Procedures and Practices.

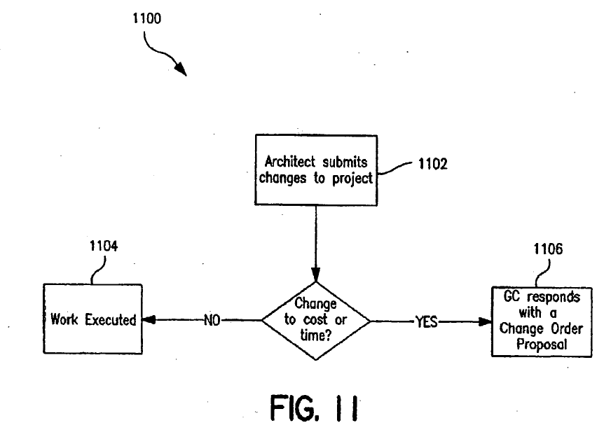

The Architects Supplemental Instructions (ASI) module 808 (FIG. 8) provides an interface for the architect to electronically submit a change in the construction project. FIG. 11 illustrates an ASI process example 1100 according to an aspect of the present invention. At step 1102, the architect submits changes to the project. If these changes would generally not require a change in cost or time to the project, at step 1104, the work is carried out. In the event that a change in time or cost would be necessary, at step 1106, the general contractor could respond with a Change Order Proposal (COP) by importing the ASI items via the COP import module.

The Architects Supplemental Instructions (ASI) module 808, among other things, provides the ability to attach a separate document to each item in the ASI, default information is automatically created upon generation of new ASI form, reducing the need for duplicate data entry. The ASI module 808 also provides the ability to display color coding status (e.g., not issued/un-finalized), keeping sequential order, and enabling actions, such as, for example, viewing an ASI and ASI history log.

The ASI Module 808 also allows a user to generate an electronic ASI form. The user is prompted to enter/select information comprising CSI code information, description, and recipient (general contractor). Once the information is saved, the user can then add an itemized list of changes they wish to have included in the proposal. Data comprising description, document attachments, and date is collected for this. Upon the creation of at least one item, the user can then finalize the document. This will send an email to the recipient (general contractor) prompting them to login in to the system and view the ASI. After reviewing the document, the recipient may choose to respond to this ASI with a Change Order Proposal document in compliance with Standard AIA Procedures and Practices.

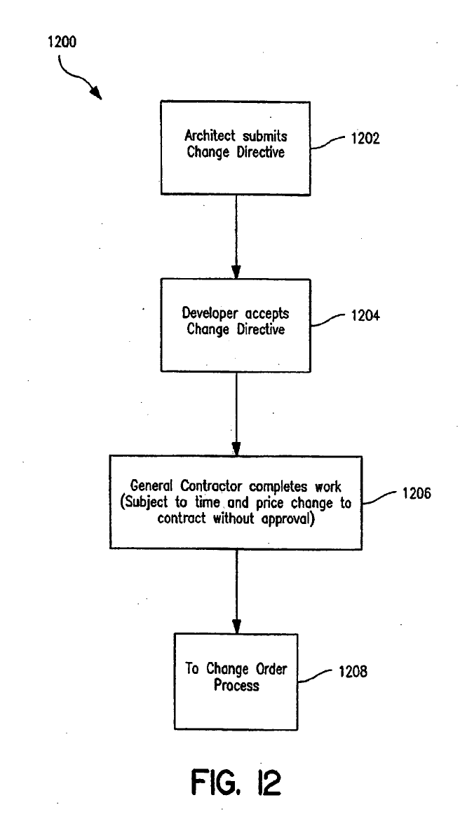

The Construction Change Directives (CCD) module 810 (FIG. 8) provides an interface for the architect to electronically issue a Change Directive to the general contractor. The changes on a CCD would be executed no matter what the change in time or cost would be. The CCD interface has a feature where you can enter estimated costs. These items would then be imported into the COP module where the exact changes in time and cost would be entered. FIG. 12 illustrates an example of the construction change directive process 1200 according to an aspect of the present invention. At step 1202, the architect submits a change directive. At step 1204, following receipt of the change directive, the developer accepts the change directive. At step 1206, the general contractor completes work based on the accepted change directive.

Returning to FIG. 8, as with the other modules within the form management system, the Construction Change Directives (CCD) module 810, among other things, provides the ability to attach a separate document to each item in the CCD, default information is automatically created upon generation of new CCD form, thus, reducing the need for duplicate data entry, provides color coding status, keeps sequential order, and facilitates actions (e.g., view ASI)

The CCD Module 810 allows a user to generate an electronic CCD form. The user is prompted to enter/select information comprising CSI code information, description, and recipient (general contractor). Once the CCD is saved, the module will then prompt the user to enter estimates for time and cost changes for the CCD. Information is collected comprising estimated pricing information, which is collected through a series of questions about the CCD (e.g., lump sum increase, decrease, etc.), estimated time information which is collected through a series of questions, where this information can be changed at anytime prior to finalizing the CCD document. Once the estimate information is saved, the user can then add an itemized list of changes they wish to have included in the proposal. Data comprising, description, document attachments, and date is collected for this. Upon the creation of at least one item, the user can then finalize the document. This will send an email to the recipient (General Contractor) prompting them to log in to the system and view the CCD. After reviewing the document, the recipient may choose to respond to this CCD with a Change Order Proposal document in compliance with Standard AIA Procedures and Practices.

The substitutions-module 812 (FIG. 8) provides an interface for a general contractor to request approval from the architect on a substitution item. This would be an item where a different vendor or manufacturer would be requested, and will most likely not require a change in time or cost.

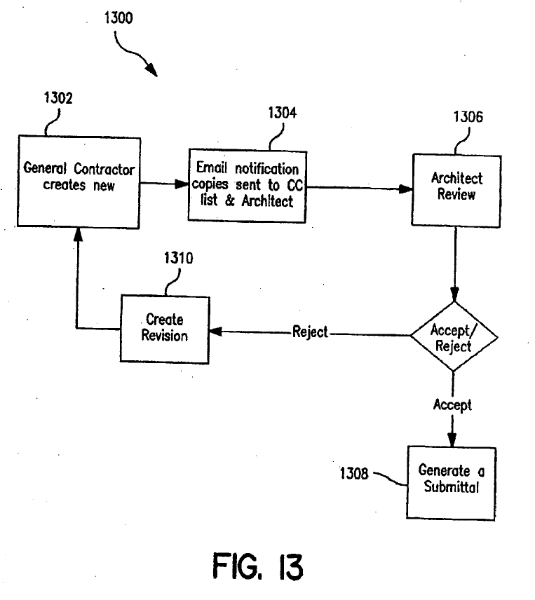

FIG. 13 illustrates the substitution process 1300 according to an aspect of the present invention. At step 1302, the general contractor proposes a new substitution item(s). At step 1304, a copy of an email notification is sent to the architect and other parties copied on the email. At step 1306, the architect reviews the substitution item, and decides whether to accept or reject the item(s).

If the architect accepts the proposed substitution, at step 1308, a submittal is generated. If the architect does not accepts the proposed substitution, at step 1310, the general contractor may creates a revision. In either case, the architect sends a notification email to the general contractor notifying the acceptance or rejection of the submitted information.

The substitutions module 812 provides, among other things, the ability to attach unlimited amount of documents to a substitution, automatic notification of substitution activity, and the ability to search and filter out substitution data (e.g., keywords).

The submittals module 814 (FIG. 8) is an effective communication tools and is very important to the coordination and timely execution of construction process. During the construction of a project, the contractor is required by the contract documents to submit certain items to the architect/engineer for review and approval. The Submittal module allows the general contractor to submit items with attachments to the architect for their approval. Then the architect has the ability to approve/reject items and notifies the general contractor.

When a user is presented with the list of submittals, these submittals can have a status that is either accepted or rejected. This list can also list all the revisions created for the rejected submittals. The can click on various titles to sort the submittal list using different criteria including Submittal Number, CSI code, and submittal status. The user may also generate new submittals for submission to the Architect. During the process of generating a new submittal, the user is required to enter data comprising CSI code, product type, product number, product manufacturer, the parties that should get the submittal creation notification, and email addresses of those that should receive carbon copy of the notification for the submittal creation. Once the user saves the submittal, he is given the option to add more details to the submittal. These options comprise deviations from the contract, vendor name and contact details, subcontractor name and contact details, and items for the submittal, where each item includes an item number, item description, quantity, and attached documents.

The option to save the submittal lets the user save the submittal without notifying anybody. This is helpful as it provides a way to create the submittal in phases. This may be the case when someone lacks enough information when they are creating the submittal. The save and notify option can be used to save the submittal and notify the architect at the same time.

A submittal may have a status such as “draft” when, for example, the general contractor is in the process of generating and editing the submittal. It may have a “pending status,” where as soon as a notification is sent to the appropriate people for the new: submittal, it is considered pending as it is awaiting a response from the architect. “Rejected” status occurs if a submittal includes a rejected item. Any submittal that has a item with status revise/resubmit is considered to be of a “revise/resubmit” status. “Approved” status applies where all of the items in a submittal are approved.

Submittal revisions can be created for a submittal if it is rejected. When the general contractor creates a revision, all of the data and items from the original submittal are brought to the revision. The general contractor then has the option to change the items and data and notify to the Architect.

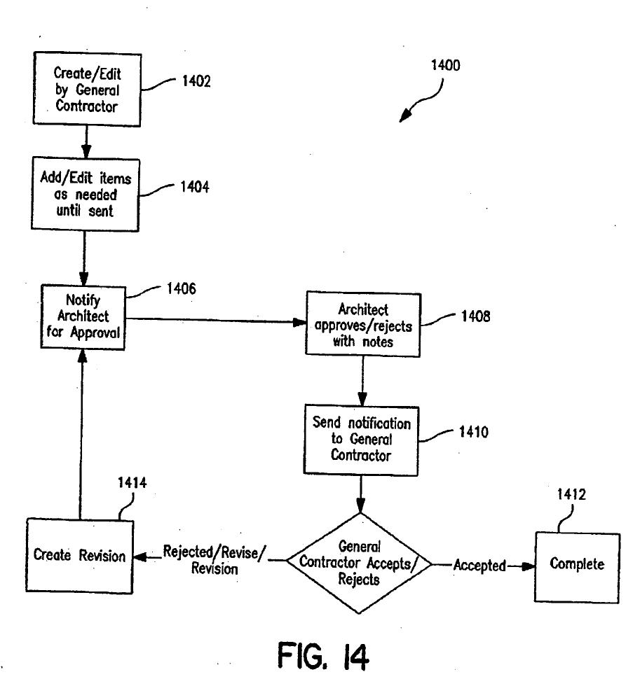

FIG. 14 illustrates a submittal process 1400 according to an aspect of the present invention, where at steps 1402 and 1404, the general contractor creates, edits or adds items that are needed to be included in the submittal. At step 1406, the architect is notified so the items may be presented for the architects approval. At step 1408, the architect approves or rejects the submitted items, and provides notes to this effect. Once the architect has approved or rejected the submittal, at step 1410, a notification is sent to the general contractor regarding the architect's decision. At step 1412, the general contractor may accept the architect's decision, or alternatively, at step 1414, the contractor may propose a revision based on the architect's rejection, which is re-presented for the architect's attention once more, as indicated at step 1406.

The Change Order Proposal (COP) module 816 (FIG. 8), provides an electronic interface for a general contractor to either respond to any of the items listed above or generate a new COP. The COP module 816 allows the general contractor to add items and sub-items with pricing to the COP form. Each sub-item may have a document attached to it for reference purposes. After all the information is compiled, the general contractor can finalize the COP, whereby the COP is sent via email to the architect for approval. Upon receipt, the architect can review the items and the costs and either accept or reject the entire COP. If any single item is not accepted, the entire COP is rejected. The architect can add a rejection note to any given sub-item in the COP, which will automatically reject the COP. The general contractor will then receive an email with the status of the COP. If rejected, the general contractor can view the notes entered by the architect and automatically create a revision, which will start the entire COP process over again until the all items are accepted. Upon approval, the COP will now be available for import in the Change Order Process.

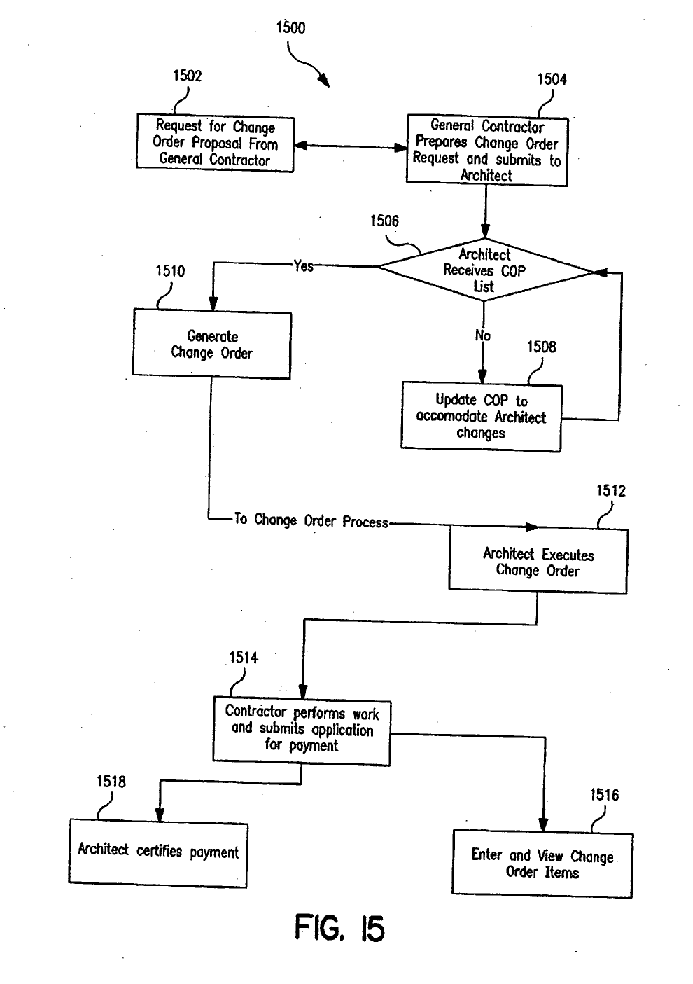

This process is further illustrated in FIG. 15, which shows a COP process 1500 according to an aspect of the present invention. At steps 1502 and 1504, the general contractor requests and prepares a Change Order Request for submission to the architect. At step 1506, the architect receives the COP prepared by the general contractor. At step 1508, if changes are needed, the COP is updated to accommodate the architect's changes. If not, at step 1510, a change order is generated. Once the Change Order is generated, at step 1512, the architect executes the Change Order. At step 1514, the contractor then performs the work indicated in the Change Order and submits an application for payment. At step 1516, the Change Order items may be entered and viewed. Also, at step 1518, the architect certifies the payment based on the submitted application.

The Change Order module 818 provides the ability to attach separate documents to each sub-item in the COP. Default information is automatically created upon generation of new COP form, which reduces the need for duplicate data entry. It also provides the ability to add pricing to each item. Markup, Overhead, and Profit are automatically calculated. Items from APR, ASI, CCD, and RFI can be imported in the event that the general contractor would need to respond with a COP.

The module change order module 818 also includes an automatic revision generation module, which virtually eliminates the need for duplicate data entry during the creation of a revision to a rejected COP; automatic email notifications of creation, approval, rejection, and revision creation; the ability to archive reject COPs and re-import them at any given time; color coding status; actions (e.g., view ASI); and actions for viewing COP and COP history logs.

The Change Order Proposal (COP) Module allows a user to generate an electronic ASI form. The user is prompted to enter/select CSI code information, description, and Recipient (general contractor). Once the information is saved, the users can then add an itemized list of changes they wish to have included in the proposal. Data comprising description, document attachments, date, and sub item information is collected for this purpose. After all the items/sub items are entered, the user can then finalize the form which will send a notification to the architect requesting approval. The import COP process allows the user to import a finalized APR, ASI, CCD, or RET into the COP process. This gives the General Contractor the ability to respond to an ASI, APR, or CCD as listed in their respective processes.

In the COP approval process, the recipient (architect) will receive the COP notification via email and will login to the system and review the items. Upon reviewing, the recipient will be able to accept, all itemized information being acceptable and agreed upon. The recipient will then send a response back to the general contractor notifying him/her of the acceptance of the COP. The recipient will also be able to reject if one or many of the sub-Items are rejected. The architect will add a rejection note to undesired items. Once added, this will automatically set the status of the entire COP to rejected. The Architect will then send a response to the General Contractor (GC) via the “send response” button. This will notify the GC of the current status.

In the revision process, in the event of a rejection, the GC has the ability to view the rejection notes and generate a revision. This process imports all the COP data into a new revision where the GC can make changes. The old information is archived in case the information would need to be re-imported again. After the modifications have been made, the General Contractor will: finalize the items. This will send the COP through the Approval Process once again.

The Change Order (CO) module 818 (FIG. 8) provides an electronic interface for the general contractor to execute the work on the items that were approved in the COP process. This process is where the time and cost listed in the contract documents would be modified. The Change Order provides, among other things automatic import functionality of approved COP's, the ability for the general contractor to import and request the architect to finalize that which would modify the contract time and price, and providing color coding status.

The Change Order functional process comprises the importing of approved Change Order Proposals. Through this module, the general contractor can select one or many approved Change Order Proposals, which will import all the items into the Change Order module, after which, enables the automatic merging of many COP's to a single Change Order. Also, the finalized module (architect) will modify the contract price via the finalize button.

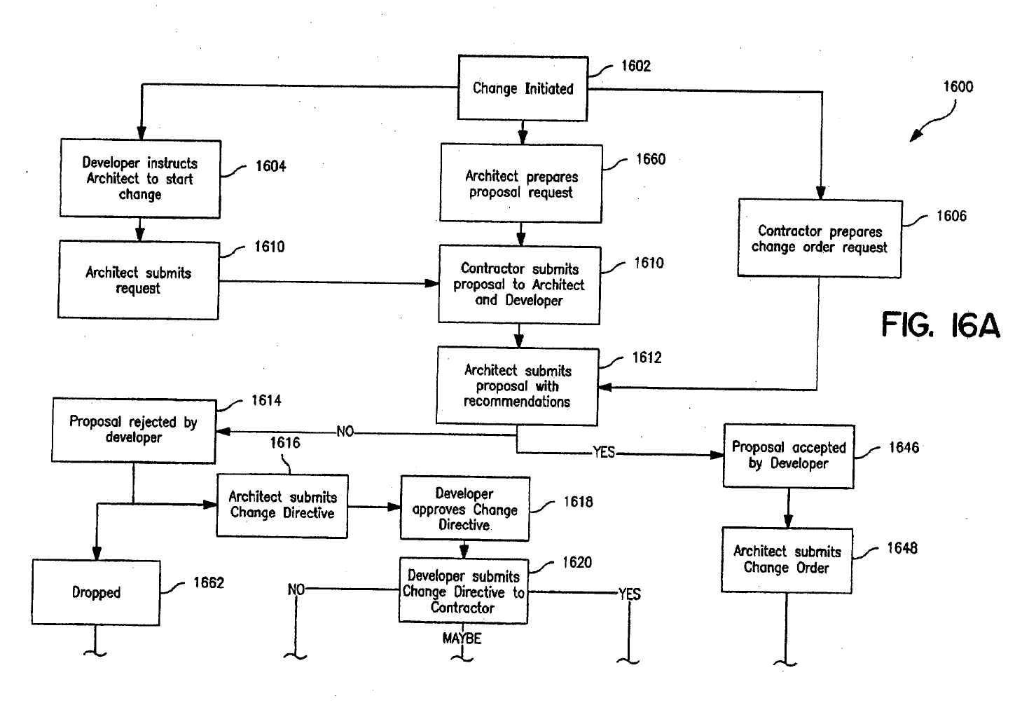

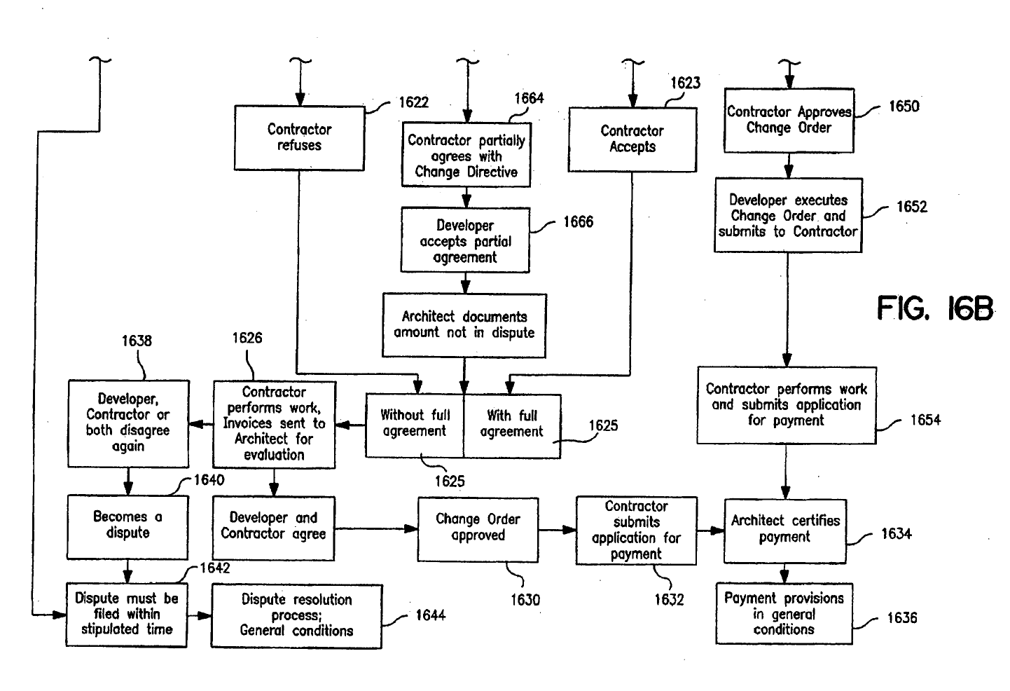

FIGS. 16A and 16B illustrate an industry process overview flowchart according to an embodiment of an aspect of the present invention. At step 1602, a change is initiated, and a developer may instruct an architect to make a change, as indicated at step 1604. At step 1608 the architect submits the request to the contractor, after which, at step 1610, the contractor submits a proposal to the developer and architect based on the received request. At step 1612, the architect sends the proposal with recommendations to the developer. If at step 1614, the proposal is rejected by the developer, at step 1616 the architect may submit a change directive. If at step 1618, the developer approves the change directive, the developer will submit the change directive to the contractor, as indicated at step 1620. If at step 1622, the contractor refuses the change directive, without full agreement, the contractor will perform the work and send the invoices to the architect for evaluation, as indicated by steps 1624 and 1626. If at step 1623, the contractor accepts the change directive, with full agreement, the contractor will perform the work and send the invoices to the architect for evaluation, as indicated by steps 1625 and 1626. At steps 1628 and 1630, the developer and contractor agree, and a change order is approved. At step 1632, the contractor submits an application for payment based on the approval. The architect then certifies the payment and payment provisions are made in general conditions, as indicated by steps 1634 and 1636. If the contractor makes the change, a change order request is made, as indicated at step 1606. At step 1638, if either or both the developer and contractor disagree, at step 1640, the issue becomes a dispute. At step 1642, the dispute is required to be filed within a stipulated time, prior to initiating a dispute resolution process, as indicated in step 1644.

If at step 1646, the proposal is accepted by the developer, at step 1648, the architect submits a change order. Once at step 1650, the architect approves the change order, at step 1652, the developer executes the change order and submits it to the contractor. Then, at step 1654, the contractor performs the work and submits an application for payment. At steps 1634 and 1636, the architect certifies the payment, and payment provisions under general conditions are carried out.

The change initiated in step 1602 may be carried out by the architect, as indicated in 1660. The process that flows from this step, is described in connection with the above steps. Similarly, at step 1606, the contractor may prepare a change order request, which is sent to the architect at step 1612.

If at step 1614, the proposal is rejected by the developer, in the case where no change directive is submitted (i.e. step 1616), the change is dropped, as indicated by step 1662. Once dropped, the dispute process of steps 1642 and 1644 is initiated.

When at step 1620, the developer submits a change directive to the contractor, at step 1664, the contractor may partially agree with the change directive. At step 1666, the developer may also accept a partial agreement.

The construction data entry system 106 (FIG. 1) is a client-server based punch list management application. It provides field workers with the ability to manage all aspects of construction/customer service/warranty functions required to punch out a typical construction project or group of projects. Powered by Microsoft SQL Server, construction data entry system 106 offers full wireless network capability and automates notification of updates. Construction data entry system 106 includes, without limitation, functionality for: wireless updates; client-server based architecture; distribution of relevant data to all sub-contractors via email, fax, printed-paper or secure Web site portal for viewing and editing live punch data; automatic copying of data to a handheld device such as Pocket PC via Microsoft ActiveSync® or Wireless Internet Connection; managing of multiple punch lists for multiple projects without returning to the office; provides project punch list access with different security levels for groups or individuals; automatically sending email or fax notification when punch data is changed or modified; and analyzing project information for future use.

The construction data entry system 106 features within the communication system, a floor maintenance setup comprising customizable floor plans to fit client need; no limitation on sub-areas added to each floor plan; copy feature allowing entire floor plans to be copied from one to another; and layout maintenance functionality to add additional details about the floor plan including how many bedrooms, bathrooms, square feet and ability to add images.

The Communications system 116 (FIG. 1) areas maintenance setup provides customizable areas to fit clients need. No limitation are imposed on areas added or associating areas with a floor plan previously added. One can create an area and associate it with a floor plan and still have the ability to add additional sub areas for that particular area that were not a part of the original floor plan. One can also change Layout functionality to modify a layout associated with an area after it is already created. It is also possible to update function after floor plan has been added and associated with existing areas. One can maintain a history log detailing if someone changed the floor plan layout, what they changed it to, the date and time it was changed, and who changed it. The user has an ability to add an area without associating it to a floor plan and create sub areas. The residence maintenance functionality for additional details provides floor plan name, status (e.g., available, pending, etc.), ability to choose owner from a drop down list of team users, rescission date, close date, floor/level, etc. Once an Area is set up it automatically updates the punch manager section of the communication system. It begins to build the grid. Any additional areas added will also automatically populate the punch manager section.

The communications system punch type maintenance and divisions provide punch type maintenance customizable to fit client needs; no limit as to how many Punch Types are added. A punch type can be created that has the ability to associate turn around time in days, apply a warranty if applicable, and apply sequencing. CSI Codes are built-in for the different divisions and one can customize divisions if CSJ codes are not used, by adding divisions, subdivisions, categories, subcategories, and items.

The communications system punch manager 266 (FIG. 2) provides functionality where, once punch types are added it begins to complete the punch manager grid with areas already in a column to the left, and punch types going across a row at the top. Also, the grid provides an “at a glance” view of where everything is in the punch process; whether or not a Punch has been started and if so what date was it started; whether or not a punch is checked out by the user logged in or if it is locked by another user; color-coding showing whether or not the punch has any items with no messages sent, late items, or items that are pending confirmation; and the status of the entire punch (Started, Pending, Not Complete, Complete).

The communications system punch type maintenance and divisions also provide an ability to view all divisions added for the particular project in one list. The list can be further broken down to view only divisions associated with a particular punch type as well as add divisions to a particular Punch Type. The punch type maintenance and divisions also includes a reporting tool that shows all of the divisions and how many items have been added relating to that particular division. It breaks down the items into percents and automatically creates a bar graph to show the problem areas. Additional reporting is also made available through individual customer requests.

The communications system viewing items provide a punch item filter, which allows the Items to be viewed based on their Status, Area, or Resource; a punch log that shows when the punch Items were added, update, deleted, by whom, and for which area. For email notification and status update there is a select all option for providing an ability to send email notification all at once for multiple items with multiple resources. There is also an ability to update multiple items to same status all at once and a printer-friendly version available for “clean”printouts.

The developer checks out the Punches he/she wants to work on while in the field. By executing a data synchronization, the punches he/she checked out will be the only punches to appear on the wireless Pocket PC or handheld communication device. This allows for better speed when the Pocket PC does not have to pull all of the information entered within the communications system.

When working from the Pocket PC, the developer can inspect the project site and add or edit items wirelessly right from their Pocket PC based upon which punches he/she checked out. When finished working on the Pocket PC, another data synchronization occurs, so the data can replicate from what was just added on the Pocket PC back to the communications system.

Back at the office, the developer would go back into the communications system to send notification to the general contractor. The developer would assign a resource to the different items he/she added while at the project site. Notification can then be sent via email to the appropriate resource for as many items as selected. If mass items are selected, only one email is sent to each resource detailing the items assigned to them rather than a separate email for each individual item.

The general contractor would receive notification for any items that have been added and selected to notify. He/she is responsible for addressing and resolving the issue. Once the general contractor has addressed and resolved the issue he/she would then change the Status of that particular Item to “Pending Confirmation.” This would send an automatic email back to the developer so that the developer knows the general contractor has fixed the issue and is awaiting confirmation.

For situations in which the developer accepts/rejects a process, if it is fixed he/she would accept it by changing the Status to “Confirmed Complete” and the process is done. The general contractor would receive notification that the item is confirmed complete. If it is not fixed, the developer would change the Status to “Reject.” The general contractor would receive automatic notification that the item has been rejected. He/she would then be responsible for readdressing the issue and fixing it. The process would continue until the developer changes the Status to “Confirmed Complete.” The developer can update the status of multiple Items within one Punch all at the same time. At anytime throughout the process the developer and general contractor can communicate by entering Comments for a particular Item to help in the process. These comments can be added from the communications system or wirelessly from the Pocket PC while out at the project site.

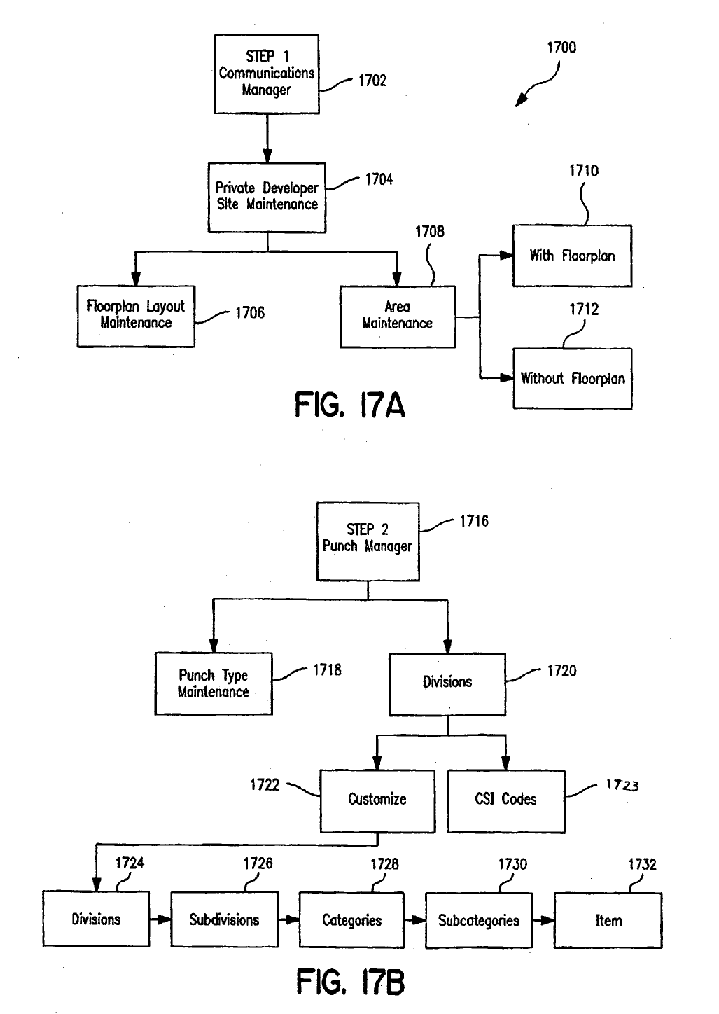

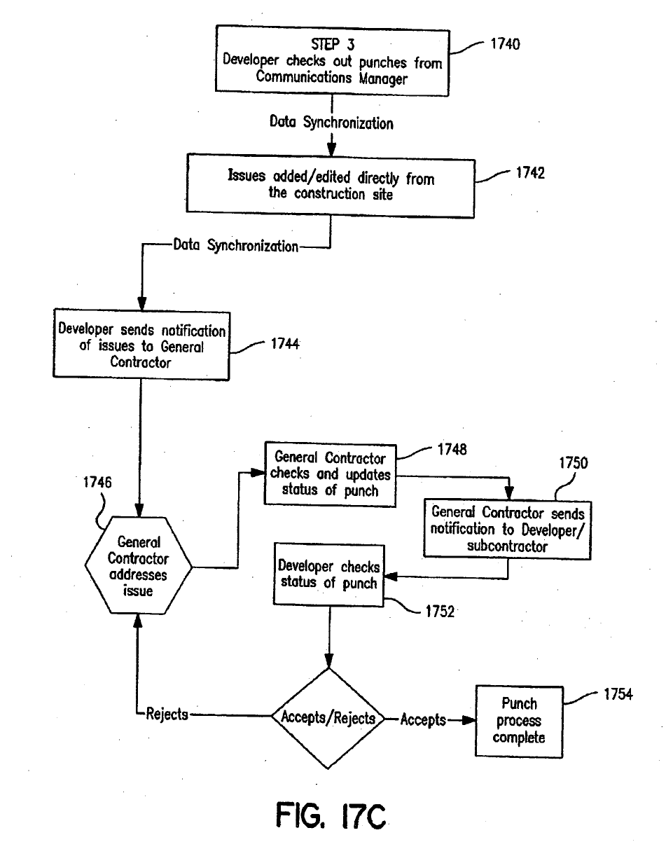

FIGS. 17A, 17B, and 17C illustrate the punch process 1700 according to an embodiment of an aspect of the present invention.

FIG. 17A illustrates an initial step in the punch process according to an embodiment of an aspect of the present invention. In a step 1702, the initial punch process is initiated through the communications system. By means of the communications system, the user may enter the private developer site maintenance area, as indicated by step 1704. From the developer site maintenance area, at step 1706, the floor plan layout maintenance can be accessed, where additional details about the floor plan can be added. For example, details regarding the number of bedrooms, bathrooms, square feet, and the ability to include images may added. As indicated, there are no limitations on sub-areas added to each floor plan. Also, the floor plans are customizable to fit customer needs.

At step 1708, an unlimited number of areas and sub-areas can be created, where as indicated by steps 1710 and 1712, the areas may or may not be associated with an existing floor plan. The areas are customizable to fit client needs and there is no limitations on the areas added.

According to an aspect of the present invention, FIG. 17B illustrates the punch manager function associated with punch process, as indicated by step 1716. At step 1718, the punch type maintenance provides no limit to the number of punch types that may be added, where the punch types are customizable to fit client needs. Once punch types are added, the punch manager completes a grid comprising areas and punch types, in which the grid provides an “at a glance” view of the state of everything in the punch process. At step 1720, different divisions may be added for a project, where the divisions are associated with a particular punch type. At step 1723, the different CSI codes may be built into the different divisions. At step 1722, customized divisions, sub-divisions, categories, sub-categories, and items may be created, as indicated by steps 1724, 1726, 1728, 1730, and 1732, respectively.

According to an aspect of the present invention, FIG. 17C illustrates the punch list checkout process via the communications system. As indicated by step 1740, the developer may checkout punches via the communication system. Using a construction data entry device, such as a Pocket PC, construction data issues may be added and/or edited directly from the construction site, as indicated by step 1742. By carrying out a data synchronization, the punches checked out by, for example, the developer, will be the only punches that appear on the construction data entry device (e.g., Pocket PC). This increases the communication speed of the information or data transfer between the communication system and the device (e.g., Pocket PC) carried by the developer or user in the field. Another data synchronization occurs based on the data and information added on the data entry device (e.g., by the developer), whereby the updated information can be transmitted back to the communication system. The developer or user may then reenter the communication system and notify the general contractor of any punch related issues, as indicated by step 1744. At step 1746, the contractor may address the raised issues, as the general contractor may be responsible for fixing the problem. Once addressed, at step 1748, the general contractor checks and updates the status of the punch issues. The general contractor then sends a notification to the developer, as indicated by step 1750. At step 1752, the developer checks the status of the punch list and either accepts or rejects the work done by the general contractor. If accepted, at step 1754, the punch process is complete. If rejected, back at step 1746, the general contractor may re-address the issue and send it back to developer until it is accepted. FIGS. 17A, 17B, and 17C illustrate the punch process 1700 according to an embodiment of an aspect of the present invention.

FIG. 17A illustrates an initial step in the punch process according to an embodiment of an aspect of the present invention. In step 1702, the initial punch process is initiated through the communications system. By means of the communications system, the user may enter the private developer site maintenance area, as indicated by step 1704. From the developer site maintenance area, at step 1706, the floor plan layout maintenance can be accessed, where additional details about the floor plan can be added. For example, details regarding the number of bedrooms, bathrooms, square feet, and the ability to include images may added. As indicated, there are no limitations on sub-areas added to each floor plan. Also, the floor plans are customizable to fit customer needs.

At step 1708, an unlimited number of areas and sub-areas can be created, where as indicated by steps 1710 and 1712, the areas may or may not be associated with an existing floor plan. The areas are customizable to fit client needs and there is no limitations on the areas added.

According to an aspect of the present invention, FIG. 17B illustrates the punch manager function associated with punch process, as indicated by step 1716. At step 718, the punch type maintenance imposes no limit on the number of punch types that may be added, where the punch types are customizable to fit clients needs. Once punch types are added, the punch manager completes a grid comprising areas and punch types. The grid provides an “at a glance” view of where everything is in the punch process. At step 1720, different divisions may be added for a project, the divisions being associated with a particular punch type. At step 1724, the different CSI codes may be built into the different divisions. At step 1722, customized divisions, sub-divisions, categories, sub-categories, and items may be created, as indicated by steps 1724, 1726, 1728, 1730, and 1732, respectively.

According to an aspect of the present invention, FIG. 17C illustrates the punch list checkout process via the communications system. As indicated by step 1740, the developer may checkout punches via the communication system. Using a construction data entry device, such as a Pocket PC, construction data issues may be added and/or edited directly from the construction site, as indicated by step 1742. By carrying out a data synchronization, the punches checked out by, for example, the developer, will be the only punches that appear on the construction data entry device (e.g., Pocket PC). This increases the communication speed of the information or data transfer between the communication system and the device (e.g., Pocket PC) carried by the developer or user in the field. Another data synchronization occurs based on the data and information added on the data entry device (e.g., by the developer). In the this way the updated information can be transmitted back to the communication system. The developer or user may then reenter the communication system and notify the general contractor of any punch related issues, as indicated by step 1744. At step 1746, the general contractor addresses the issue, as the party responsible for fixing the problem. Once addressed, at step 1748, the general contractor checks and updates the status of the punch issues. The general contractor then sends a notification to the developer, as indicated by step 1750. At step 1752, the developer checks the status of the punch and either accepts or rejects the work done by the general contractor. If accepted, at step 1754, the punch process is complete. If rejected, back at step 1746, the general contractor may re-address the issue and send it back to developer until it is accepted.

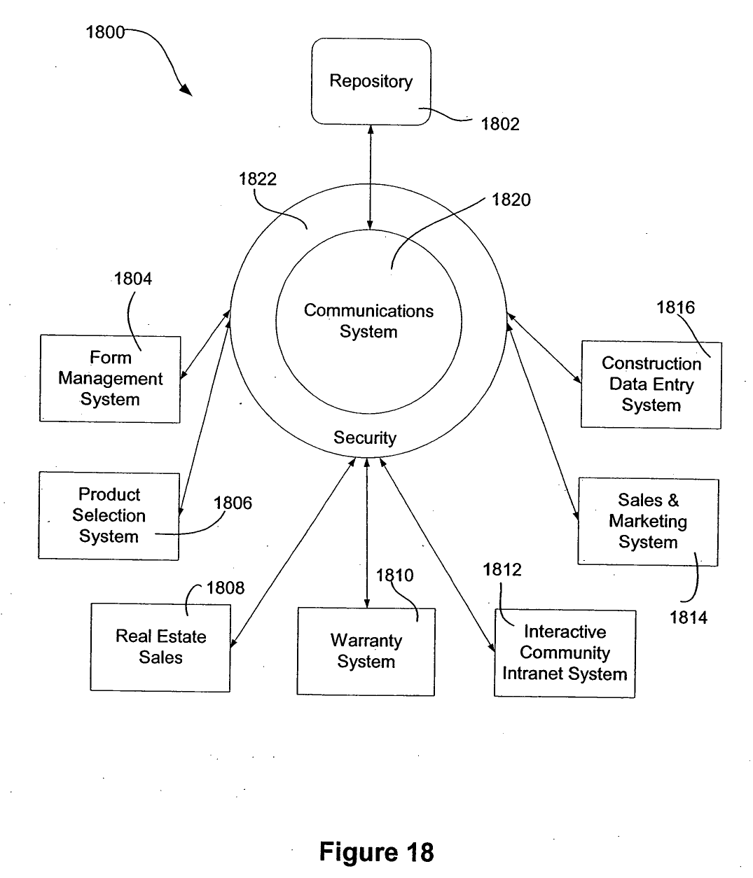

FIG. 18 illustrates a system representation of the DMS system 1800 showing-access between the application modules and content stored in repository 1802, according to an embodiment of an aspect of the present invention. Application modules 1804, 1806, 1808, 1810, 1812, 1814, and 1816 may access stored content and information in repository 1802 through communications system 1820. Repository 1802 may comprise one or more database systems, where each project may be assigned to its own designated database. All stored documentation and file management associated with a construction project are accessible from the repository through the different modules 1804, 1806, 1808, 1810, 1812, 1814, 1816, where the administrative and security tools 1822 associated with the communications system 1820, provides a tiered layer of security access to the various entities or members participating in the construction project. Therefore, based on their respective roles in the project or organization, project managers, project team members, and administrative staff are provided with different levels of access to the content or information stored in repository 1802.

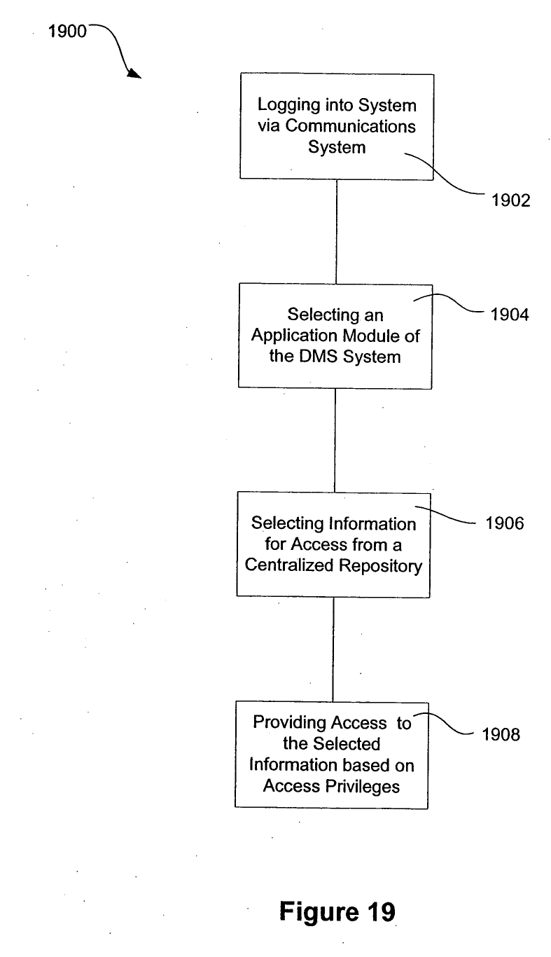

FIG. 19 illustrates a method of accessing content and information using the DMS system (FIG. 18) according to an aspect of the present information. At step 1902, a user or member of a project team (e.g., project manager) associated with a development project logs into the DMS system. At step 1904, the user may select an application module based on the user's role in the project and the information the user would like to access form a centralized repository associated with the DMS system. At step 1906, the user selects the information or content of interest. Based on the user's access privileges, content or data is accessed from the repository and provided to the user, as indicated by step 1908. If the user does not have sufficient access rights to the content, then this information may not be accessed and displayed to the user. Also, based on the user's role and access privileges within the project, the user may have both read and write privileges, where the user may modify and/or update the data or content in the centralized repository. Some user's may only have read rights, where based on their role in the project, they may only view certain data or content.

This application claims the benefit, under 35 U.S.C. § 119(e), of provisional patent application No. 60/474,740, filed on May 30, 2003, the contents of which are incorporated by reference herein in their entirety.

In addition to the embodiments of the aspects of the present invention described above, those of skill in the art will be able to arrive at a variety of other arrangements and steps which, if not explicitly described in this document, nevertheless embody the principles of the invention and fall within the scope of the appended claims. For example, the ordering of method steps is not necessarily fixed, but may be capable of being modified without departing from the scope and spirit of the present invention.

What is claimed is:

1. An internet based development management system for managing real estate projects, the management involving a plurality of entities each playing a role in at least one of the real estate projects, the system comprising:
(a) a form management system for providing online construction form communication and tracking management procedures for at least a subset of the plurality of entities involved in the real estate projects;
(b) a construction data-entry communication device for entry and transmission of construction related data; and
(c) a communications system for providing communications between the form management system and construction data-entry communication device, wherein the communications system receives transmitted construction development site data from the data-entry device and transmits the development site data to the form management system.

2. The system according to claim 1, wherein one of the plurality of entities comprises a homeowner, the system further comprising an intranet system in communication with the communications system for allowing access to the development management system by the homeowner.

3. The system according to claim 2, further comprising a product selection system accessible by the homeowner.

4. The system according to claim 3, wherein the residence customizations comprise one of the group consisting of construction changes and custom feature requests.

5. The system according to claim 2, further comprising a warranty system for generating and tracking warranty requests, wherein the warranty system is accessible by the homeowner.

6. The system according to claim 2, wherein the homeowner can access, via the intranet, data in the development management system relating to at least one of the group consisting of residence customizations, warranty requests, and association information.

7. The system according to claim 1, further comprising a sales and marketing system in communication with the communications system for providing marketing for the at least one real estate product during at least one of the group consisting of a pre-construction phase, a construction phase, and a post-construction phase.

8. The system according to claim 1, wherein the form management system comprises a plurality of form modules adapted to acquire, complete, report, and track construction forms between a single data storage location on behalf of a subset of the plurality of entities.

9. The system according to claim 8, wherein the subset of the plurality of entities comprise at least one of the group consisting of developers, builders, architects, and contractors.

10. The system according to claim 8, wherein at least one of the plurality of form modules comprises a request module adapted to provide the project members with access to an electronically generated request for information (RFI) form.

11. The system according to claim 8, wherein at least one of the plurality of form modules comprises an architect request module adapted to provide an architect with access to an electronically generated architects supplemental instructions (ASI) form for submission of changes in the real estate projects.

12. The system according to claim 8, wherein at least one of the plurality of form modules comprises a construction change module adapted to provide an architect with access to an electronically generated construction change directive form for issuing a change directive on behalf of an architect to a contractor.

13. The system according to claim 8, wherein at least one of the plurality of form modules comprises a substitution module adapted to provide a contractor with access to an electronically generated substitutions form for generating requests for substitute construction related items from an architect.

14. The system according to claim 8, wherein at least one of the plurality of form modules comprises a submittal module adapted to provide a contractor with access to an electronically generated item submittal form for contractually providing at least one of the group consisting of architects and engineers with a list of submittals.

15. The system according to claim 8, wherein at least one of the plurality of form modules comprises a change order proposal (COP) module adapted to provide a contractor with access to an electronically generated change order proposal form for adding items and pricing information for approval by an architect.

16. The system according to claim 15, wherein at least one of the plurality of form modules comprises a change order (CO) module adapted to merge at least one approved electronically generated change order proposal form into a single electronically generated change order form for contract price finalizing.

17. The system according to claim 1, wherein the construction data-entry communication device comprises:
(a) a wireless interface for communication with the communications system based on a client/server relationship; and
(b) a punch list management application for processing construction related data associated with various aspects of the real-estate projects.

18. A computer implemented system for centralized management of a plurality of construction projects, the management of the plurality of construction projects involving a plurality of entities each having a respective role, the system comprising:
(a) a communications management system; and
(b) a plurality of modules in communication with the communications management system, each module providing functionality associated with a respective aspect of the management of each of the plurality of projects, each module being accessible to respective entities having access authorization, and adapted to follow a pre-established workflow associated with the management of the plurality of projects.

19. The computer implemented system according to claim 18, wherein the plurality of modules comprises at least one of the group consisting of a form management system, a construction data-entry communications device, a community intranet system, a product selection system, a warranty system, and an interactive sales and marketing system.

20. The computer implemented system according to claim 18, wherein the communications management system comprises:
(a) at least one data repository for providing documentation and file management associated with the construction project from any location comprising internet access; and
(b) a project application interface for providing web-based access to the plurality of modules, wherein the modules access the at least one data repository based on selected functionality and respective access authorization of the entities.

21. The computer implemented system according to claim 18, wherein the entities comprise at least one of the group consisting of architects, engineers, developers, contractors, new homeowners, and commercial tenants.

22. A computer implemented method for centralized management of a construction project, comprising the steps of:
(a) maintaining a central repository in a storage medium, the storage medium comprising data relating to the project; and
(b) in response to a request by one of a plurality of members of a community of interest having a predefined role, for the project, providing selective access to data in the central repository on the basis of the predefined role.

23. The method according to claim 22, wherein the predefined role comprises activities associated with electronic form management and tracking.

24. The method according to claim 22, wherein the predefined role comprises activities associated with wirelessly communicating punch date between a construction data-entry communication device and the central repository.

25. The method according to claim 22, wherein the predefined role comprises activities associated with at least one of the group consisting of marketing and sales, warranty requests, product selection, and interactive community intranet access.

26. The method according to claim 22, wherein selected access is determined based on the predefined role of each of the plurality of members of a community of interest.

27. The method according to claim 22, wherein the community of interest comprises at least one of the group consisting of homeowners, tenants, developers, contractors, architects, engineers, and real-estate sales and marketing personnel.
